(19) United States
(12) Patent Application Publication
(10) Pub. No.: US 2021/0117760 A1
(43) Pub. Date: Apr. 22, 2021

(54) METHODS AND APPARATUS TO OBTAIN WELL-CALIBRATED UNCERTAINTY IN DEEP NEURAL NETWORKS

(71) Applicant: Intel Corporation, Santa Clara, CA (US)

(72) Inventors: Ranganath Krishnan, Hillsboro, OR (US); Omesh Tickoo, Portland, OR (US); Nilesh Ahuja, Cupertino, CA (US); Ibrahima Ndiour, Portland, OR (US); Mahesh Subedar, Laveen, AZ (US)

(21) Appl. No.: 17/133,072

(22) Filed: Dec. 23, 2020

Related U.S. Application Data
(60) Provisional application No. 63/033,660, filed on Jun. 2, 2020.

(51) Int. Cl. G06N 3/04; G06N 3/08; G06K 9/62

(52) U.S. Cl. CPC G06N 3/0472; G06K 9/6256; G06K 9/6262; G06N 3/08

(57) ABSTRACT

Methods, systems, and apparatus to obtain well-calibrated uncertainty in probabilistic deep neural networks are disclosed. An example apparatus includes a loss function determiner to determine a differentiable accuracy versus uncertainty loss function for a machine learning model, a training controller to train the machine learning model, the training including performing an uncertainty calibration of the machine learning model using the loss function, and a post-hoc calibrator to optimize the loss function using temperature scaling to improve the uncertainty calibration of the trained machine learning model under distributional shift.

### FIELD OF THE DISCLOSURE

This disclosure relates to deep neural networks, and, more particularly, to methods and apparatus to obtain well-calibrated uncertainty in deep neural networks.

### BACKGROUND

Deep neural networks (DNNs) have revolutionized the field of artificial intelligence (AI) with state-of-the-art results in many domains including computer vision, speech processing, and natural language processing. Although DNNs provide state-of-the-art model accuracy, quantification of accurate uncertainty is still an ongoing challenge. Obtaining reliable and accurate quantification of uncertainty estimates from deep neural networks and incorporating such quantification into decision-making is essential for AI-based applications where safety is critical, including applications related to autonomous vehicles, robotics, and medical diagnosis.

### BRIEF DESCRIPTION OF THE DRAWINGS

FIG. 1 illustrates a first example of a distributional shift failure that is addressed using the teachings of this disclosure.

FIG. 2 illustrates a second example of a distributional shift failure and an associated uncertainty quantification performed in accordance with the teachings of this disclosure.

FIG. 3 is an example accuracy versus uncertainty confusion matrix for model predictions performed in accordance with the teachings of this disclosure.

FIGS. 4A and 4B illustrate example accuracy versus uncertainty quantifications used for improved decision-making in artificial intelligence (AI)-related applications in accordance with teachings of this disclosure.

FIG. 5 illustrates an example system constructed in accordance with teachings of this disclosure and including an example uncertainty calibrator to obtain well-calibrated uncertainty in deep neural networks.

FIG. 6 is a block diagram of the example uncertainty calibrator of FIG. 5, including an example loss function determiner, an example training controller, and an example post-hoc calibrator constructed in accordance with teachings of this disclosure.

FIG. 7 is a flowchart representative of example machine readable instructions which may be executed to implement the example uncertainty calibrator of FIG. 6.

FIG. 8 is a flowchart representative of example machine readable instructions which may be executed to implement elements of the example uncertainty calibrator of FIG. 6, the flowchart representative of instructions used to determine an accuracy versus uncertainty (AvUC) loss function for a stochastic neural network.

FIG. 9 is a flowchart representative of example machine readable instructions which may be executed to implement elements of the example uncertainty calibrator of FIG. 6, the flowchart representative of instructions used to determine an accuracy versus uncertainty (AvUC) loss function for a deterministic neural network.

FIG. 10 is a flowchart representative of example machine readable instructions which may be executed to implement elements of the example uncertainty calibrator of FIG. 6, the flowchart representative of instructions used to train a machine learning model using the AvUC loss function determined in FIG. 8 and/or FIG. 9.

FIG. 11 is a flowchart representative of example machine readable instructions which may be executed to implement elements of the example uncertainty calibrator of FIG. 6, the flowchart representative of instructions used to perform a post-hoc model calibration.

FIG. 12 includes example programming code representative of machine readable instructions of FIGS. 7-8 that may be executed to implement the example uncertainty calibrator of FIG. 6 to perform accuracy versus uncertainty calibration (AvUC) improvement for a stochastic neural network.

FIG. 13 includes example programming code representative of machine readable instructions of FIGS. 7 and 9 that may be executed to implement the example uncertainty calibrator of FIG. 6 to perform accuracy versus uncertainty calibration (AvUC) optimization for a deterministic neural network.

FIGS. 14A, 14B, 14C, 14D, and 14E include example model calibration comparisons of the approaches disclosed herein with various high-performing non-Bayesian and Bayesian methods across multiple combinations of data shift, including data shift at different levels of shift intensities (1-5), based on ResNet-50 deep neural network architectures on ImageNet datasets.

FIGS. 15A, 15B, 15C, 15D, and 15E include example model calibration comparisons of the approaches disclosed herein with various high-performing non-Bayesian and Bayesian methods across multiple combinations of data shift, including data shift at different levels of shift intensities (1-5), based on ResNet-20 deep neural network architectures on CIFAR10 datasets.

FIGS. 16A and 16B include calibration results under distributional shift using ImageNet and CIFAR 10 datasets.

FIG. 17 illustrates a comparison between accuracy versus uncertainty measures on in-distribution and under dataset shift at different levels of shift intensities.

FIGS. 18A, 18B, 18C, 18D, 18E, 18F, 18G, 18H, and 18I illustrate model confidence and uncertainty evaluation under distributional shift, including accuracy as a function of confidence, probability of the model being uncertain when making inaccurate predictions, and a density histogram of entropy on out-of-distribution (OOD) data.

FIGS. 19A, 19B, 19C, 19D, 19E, 19F, and 19G illustrate density histograms of predictive entropy on an ImageNet in-distribution test set and data shifted with Gaussian blur of intensity.

FIG. 20 illustrates distributional shift detection performance using predictive uncertainty on ImageNet and CIFAR10 datasets based on data shifted with Gaussian blur of intensity.

FIG. 21 illustrates example image corruptions and perturbations used for evaluating model calibration under dataset shift, including different shift intensities for Gaussian blur.

FIGS. 22A, 22B, 22C, 22D, and 22E illustrate example results for monitoring metrics and loss functions while training a mean-field stochastic variational inference (SVI)-based Accuracy versus Uncertainty Calibration (AvUC) model.

FIGS. 23A and 23B illustrate example results for monitoring accuracy and AvU-based metrics on test data after each training epoch using the mean-field stochastic variational inference (SVI)-based Accuracy versus Uncertainty Calibration (AvUC) model.

FIGS. 24A, 24B, 24C, 24D, 24E, and 24F illustrate example results for confidence and uncertainty evaluation under distributional shift using the defocus blur and glass blur image corruptions on ImageNet and CIFAR datasets.

FIGS. 25A, 25B, 25C, 25D, 25E, and 25F illustrate example results for confidence and uncertainty evaluation under distributional shift using the speckle noise and shot noise image corruptions on ImageNet and CIFAR datasets.

FIGS. 26A, 26B, 26C, 26D, 26E, 26F, 26G, and 26H illustrate density histograms of predictive entropy with out-of-distribution (00D) data and in-distribution data based on ResNet-20 trained with CIFAR10.

FIGS. 27A and 27B illustrate example distributional shift detection using predictive entropy.

FIGS. 28A, 28B, and 28C illustrate results of AvU temperature scaling based on post-hoc calibration, including a comparison with conventional temperature scaling that optimizes negative log-likelihood loss.

FIG. 29 is a block diagram of an example processor platform structured to execute the example machine readable instructions of FIGS. 7, 8, 9, and/or 10 to implement the example uncertainty calibrator of FIG. 5.

FIG. 30 is a block diagram of an example software distribution platform to distribute software (e.g., software corresponding to the example computer readable instructions of FIGS. 7, 8, 9 and/or 10) to client devices such as consumers, retailers, and/or original equipment manufacturers.

The figures are not to scale. In general, the same reference numbers will be used throughout the drawing(s) and accompanying written description to refer to the same or like parts, elements, etc.

Descriptors “first,” “second,” “third,” etc., are used herein when identifying multiple elements or components which may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Methods, systems, and apparatus to obtain well-calibrated uncertainty in deep neural networks are disclosed herein. Deep neural networks (DNNs) have revolutionized the field of artificial intelligence (AI) with state-of-the-art results in many domains including computer vision, speech processing, and natural language processing. More specifically, neural networks are used in machine learning to allow a computer to learn to perform certain tasks by analyzing training examples. For example, an object recognition system can be fed numerous labeled images of objects (e.g., cars, trains, animals, etc.) to allow the system to identify visual patterns in such images that consistently correlated with a particular object label. DNNs rely on multiple layers to progressively extract higher-level features from raw data input (e.g., from identifying edges of a human being using lower layers to identifying actual facial features using higher layers, etc.). Although DNNs can provide state-of-the-art model accuracy, quantification of accurate uncertainty is still an ongoing challenge. For example, a DNN can be used to determine whether an object on a road is another vehicle or a human, where quantification of accurate uncertainty would provide an estimate of the level of uncertainty associated with the prediction by the DNN that the object is, in fact, a vehicle. Obtaining reliable and accurate quantification of uncertainty estimates from DNNs and incorporating such uncertainty quantifications in decision-making is essential for safety when using artificial intelligence (AI)-based applications in autonomous vehicles, robotics, and/or medical diagnosis. For example, a well-calibrated model should be certain about its predictions when it is accurate and indicate high uncertainty when making inaccurate predictions.

Calibration of deep neural networks involves the challenge of accurately representing predictive probabilities with true likelihood. Existing research to achieve model calibration and robustness in DNNs can be broadly classified into three categories: (i) post-processing calibration, (ii) training the model with data augmentation for better representation of training data, and (iii) probabilistic methods with approximate Bayesian and non-Bayesian formulation for DNNs towards better representation of model parameters. However, performing uncertainty calibration in AI models is challenging, as there is no ground truth (e.g., information provided via actual observation instead of inference) available for uncertainty estimates. For example, when the AI models are deployed in the real-world, it is common that the observed data distribution will shift away from the training data distribution, or even observe completely novel data (out-of-distribution). While negative log likelihood (NLL) loss, also known as cross entropy loss, is commonly used for training neural networks in multi-class classification tasks, such models are readily overfitted to NLL loss while mainly focused on improving accuracy and are prone to over-confidence.

Furthermore, existing approaches focus on maximizing likelihood of higher accuracy (i.e. achieving the best accuracy), but do not focus on obtaining a well-calibrated uncertainty estimation. Furthermore, existing calibration methods do not consider accounting for predictive uncertainty estimation while training the model, due to the challenge that ground-truth data is not available for uncertainty estimates. For example, post-processing calibration on a validation dataset does not guarantee calibration under a distributional shift. With data augmentation methods, it is difficult to introduce a wide spectrum of perturbations and corruptions during training time that represents all possible conditions in real-world deployment. Likewise, approximate inference methods cause the predictions to be either significantly underconfident or overconfident as they tend to fit an approximation to a local mode and do not capture the full posterior.

Well-calibrated uncertainties from AI models can help in multiple real-world applications (i.e., autonomous driving, robotics, medical diagnosis, security surveillance, etc.) that enables safer and more robust artificial intelligence-based solutions. Uncertainty estimation can assist AI practitioners and users to better understand predictions (i.e., to know “when to trust” and “when not to trust” the model predictions, especially in high-risk safety critical applications). Likewise, reliable uncertainties from models can be used for identifying out-of-distribution data, while improving AI security by introducing robustness against adversarial and data-poisoning attacks in deep neural networks. Additionally, multimodal fusion provides for a fall back to reliable modes of sensing, while active learning enables continuous learning of models identifying distributional shift, in addition to ensuring the presence of a “human-in-the-loop”. Obtaining well-calibrated uncertainties under distributional shift is therefore important to build robust AI systems for successful deployment in a real-world setting and caution AI users/practitioners about possible risks.

Methods, systems, and apparatus disclosed herein obtain well-calibrated uncertainty in deep neural networks. In examples disclosed herein, optimization methods are used to leverage the relationship between accuracy and uncertainty as an anchor for uncertainty calibration. In the examples disclosed herein, a differentiable accuracy versus uncertainty loss function for training neural networks is developed to allow the model to learn to provide well-calibrated uncertainties in addition to improved accuracy. In some examples disclosed herein, the same methodology can be extended for post-hoc uncertainty calibration on pre-trained models. Using the examples disclosed herein, a state-of-the-art model calibration is developed and compared to high-performing methods on image classification tasks under distributional shift conditions.

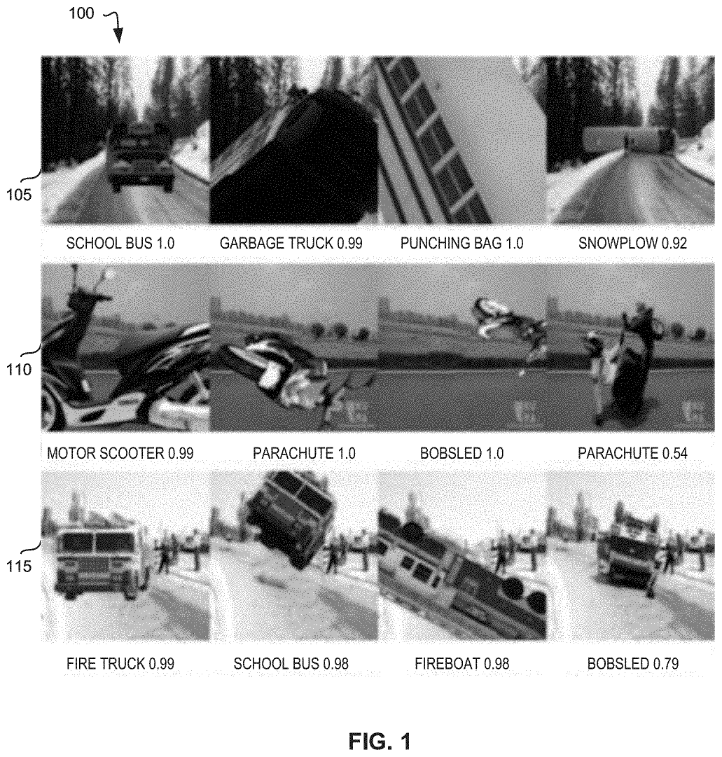

FIG. 1 illustrates a first example of a distributional shift failure 100 that is addressed using the teachings of this disclosure. As shown in the example of FIG. 1, models can perform well when using a test set accuracy evaluation, but can also fail in deployment due to a sudden shift in the distribution of data. In some examples, training a model using a test set that has substantially different characteristics from the object characteristics that the model can encounter during deployment can result in inaccurate object identification. In the example of FIG. 1, several instances of distributional failure are shown using objects such as a school bus 105, a motor scooter 110, and a fire truck 115. If a model is trained to recognize images of a school bus such that the model only recognizes the school bus when it detects features that are associated with a school bus, such a model can classify the school bus correctly (e.g., a score of 1.0, indicating a perfect match). However, when the same image of the school bus is inverted or re-sized, the model in the example of FIG. 1 classifies the re-positioned and/or re-sized school bus as a garbage truck (0.99), a punching bag (1.0), or a snowplow (0.92). Despite the inaccurate classification, there is no indication that there may be a level of inaccuracy associated with the prediction, as the classification score remains high (e.g., 0.92-1.0). In the example of the motor scooter 110, an image of an actual motor scooter is ranked with a score of 0.99, while a re-positioned and/or re-sized image classified as a parachute is ranked with a similar score to a bobsled (1.0). However, the positioning of the object can influence the model's sense of classification certainty (e.g., another image of the motor scooter classified as a parachute has a certainty score of 0.54). Likewise, a fire truck 115 can instead be identified as a school bus (0.98), a fireboat (0.98), or a bobsled (0.79), which the inaccurate identifications nevertheless having a high certainty score (0.98-0.79), which can result in not only errors when the model is deployed in the wild (e.g., not under training conditions), but also potentially unintended consequences (e.g., a stop-sign not being correctly identified in an autonomous driving situation, where an autonomous vehicle might not stop as expected). As such, despite the fact that in the wild the model is less likely to encounter the re-positioned and/or re-sized object images as illustrated in the example of FIG. 1 and more likely to encounter the objects as they appear in the example images of the first column (e.g., school bus 105, motor scooter 110, fire truck 115), the model should be able to inform the user of the actual level of uncertainty associated with the classified images.

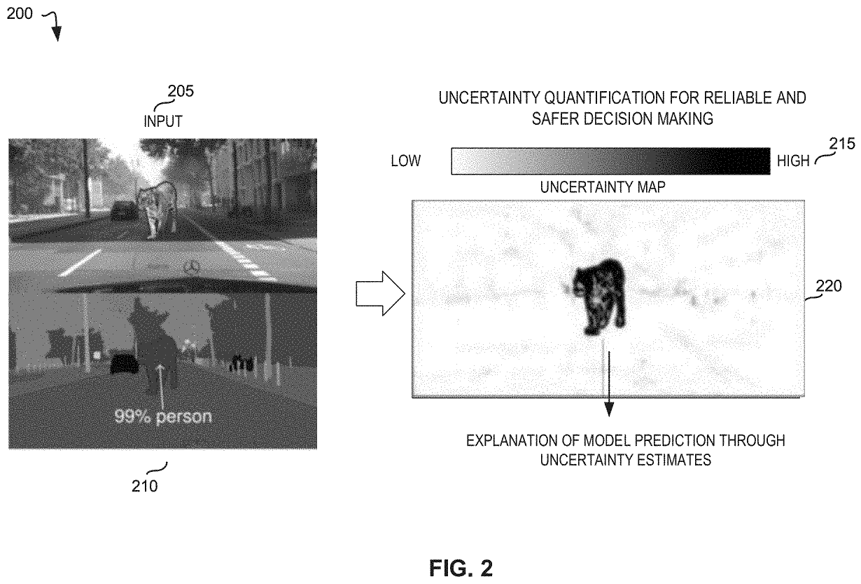

FIG. 2 illustrates a second example of a distributional shift failure 200 and an associated uncertainty quantification. In the example of FIG. 2, a model can receive an input 205 (e.g., an image of a tiger on a road), and provide an output with a high level of certainty (e.g., 99%) that the input image 205 includes an image of a person. The use of an uncertainty quantification can provide classification results with higher reliability for safer decision-making, as described using the methods and apparatus disclosed herein. Such an uncertainty quantification can permit uncertainty mapping (e.g., using an example uncertainty map 215) that allows the model to communicate to a user the areas of pixel classification that are highly certain (e.g., edges of an object) versus areas of image classification that are more uncertain (e.g., internal features of the object), thereby providing an explanation of model prediction through uncertainty estimates (e.g., example visual uncertainty estimate 220). For example, a well-calibrated model should be confident about its predictions when it is accurate and indicate high uncertainty when making inaccurate predictions. Given that modern neural networks tend to be overconfident on incorrect predictions (e.g., as shown using the distributional shift failure 100 of FIG. 1) and can produce unreliable predictions under distributional shift, obtaining reliable uncertainties even under distributional shift is important for building robust AI systems for successful deployment in real-world settings. As described herein, an accuracy versus uncertainty (AvU) calibration loss function for probabilistic deep neural networks can result in models that are confident on accurate predictions and indicate higher uncertainty when accuracy is diminished.

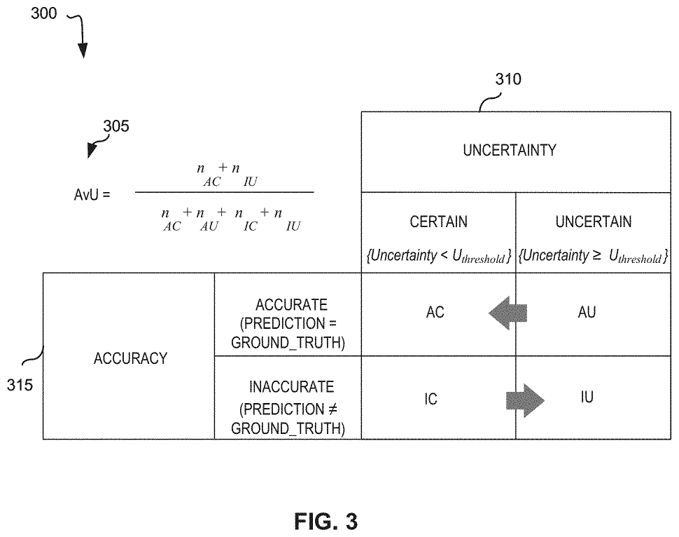

FIG. 3 is an example accuracy versus uncertainty confusion matrix 300 for model predictions performed in accordance with the teachings of this disclosure. The accuracy versus uncertainty confusion matrix 300 includes the number of accurate and certain (nAC) predictions, the number of inaccurate and uncertain (nIU) predictions, the number of accurate and uncertain (nAU) predictions, and the number of inaccurate and certain (nIC) predictions. As such, the AvU metric 305 representing accuracy versus uncertainty (AvU) is based on nAC, nIU, nAU, and nIC. For example, a reliable model will provide a higher AvU score (i.e. being confident when making accurate predictions and indicating high uncertainty when making incorrect predictions, as presented by the numerator of the AvU metric 305). For example, accuracy 315 is defined based on an accurate prediction (e.g., the prediction being equal to the ground truth data) and an inaccurate prediction (e.g., the prediction not being equal to the ground truth data). Similarly, example uncertainty 310 is defined based on an uncertainty being less than the uncertainty threshold (e.g., certain prediction) or an uncertainty being greater or equal to the uncertainty threshold (e.g., uncertain prediction). In order to perform uncertainty calibration without ground-truth availability of uncertainty estimates, an optimization method can be developed to leverage the relationship between accuracy and uncertainty as an anchor for uncertainty calibration. For example, methods disclosed herein can be used to train deep neural network classifiers (e.g., Bayesian and non-Bayesian) that result in models that are confident on accurate predictions and indicate high uncertainty when they are likely to be inaccurate. While the objective is to maximize AvU, the function itself is not differentiable. As such, methods and apparatus disclosed herein describe a differentiable AvU loss function that can be used for training probabilistic deep neural networks, as well as post-hoc calibration of the models. For example, the AvU metric 305 as defined in Equation 1 can be optimized and computed for a mini-batch of data samples while training the model. The model calibration can be improved by introducing AvU loss when training the classification networks, where AvU is utilized in the context of optimization to obtain well calibrated uncertainties. To estimate the AvU metric during each training step, outputs within a mini-batch can be grouped into the four different categories: (i) accurate and certain (AC), (ii) accurate and uncertain (AU), (iii) inaccurate and certain (IC), and (iv) inaccurate and uncertain (IU), as described in greater detail below.

In order to develop the AvU loss function, a multi-class classification problem on a large labeled dataset D can be considered, with N examples, in accordance with Equation 1 below:

D={(xₙ,yₙ)}ₙ₌₁^{N} Equation 1

The dataset D can further be partitioned into M mini-batches, in accordance with Equation 2:

D={Dₘ}ₘ₌₁^{M} Equation 2

During training, a group of randomly sampled examples (e.g., mini-batches) can be processed per iteration, wherein each batch contains B=N/M examples, in accordance with Equation 3:

Dₘ={(xᵢ,yᵢ)}ᵢ₌₁^{B} Equation 3

For each example with an input xᵢ∈χ and yᵢ∈= [symbol] ={1, 2, . . . , k} representing the ground-truth class label, pᵢ(y∥xᵢ, w) is made to represent output from the neural network, defined as f_{w}(y|xᵢ). Furthermore, ŷᵢ, =arg max_{y∈} [symbol] pᵢ(y|xᵢ, w) can be defined as the predicted class label, pᵢ=max_{y∈} [symbol] pᵢ(y|xᵢ, w) can be defined as the confidence (e.g., probability of predicted class ŷᵢ), and uᵢ=−Σ_{y∈} [symbol] pᵢ(y|xᵢ, w) log pᵢ(y|xᵢ, w) can be defined as the predictive uncertainty estimate for the model prediction. A threshold above which prediction is considered to be uncertain can be represented by uₜₕ while an indicator function is represented by [symbol] . In the case of probabilistic models, predictive distribution can be obtained from T stochastic forward passes (e.g., Monte Carlo samples), in accordance with Equation 4:

$${p}_{i} ( y \vert {x}_{i} , w ) = \frac{1}{T} {\sum }_{t = 1}^{T} {p}_{i}^{t} ( y \vert {x}_{i} , {w}_{t} ) \qquad Equation 4$$

Meanwhile, the indicator functions can be defined as shown below in Equations 5-8:

$$\begin{matrix}{n}_{AU} := {\sum }_{i} 𝕀 ( {\hat{y}}_{i} = {y}_{i} and {u}_{i} > {u}_{th} ) & Equation 5 \\ {n}_{IC} := {\sum }_{i} 𝕀 ( {\hat{y}}_{i} \neq {y}_{i} and {u}_{i} \leq {u}_{th} ) & Equation 6 \\ {n}_{A C} := {\sum }_{i} 𝕀 ( {\hat{y}}_{i} = {y}_{i} and {u}_{i} \leq {u}_{th} ) & Equation 7 \\ {n}_{IU} := {\sum }_{i} 𝕀 ( {\hat{y}}_{i} \neq {y}_{i} and {u}_{i} > {u}_{th} ) & Equation 8\end{matrix}$$

An AvU loss function representing a negative log AvU can be defined according to Equation 9:

$${ℒ}_{AvU} := log ( 1 + \frac{{n}_{AU} + {n}_{IC}}{{n}_{A C} + {n}_{IU}} ) \qquad Equation 9$$

In order to make the loss function differentiable with respect to neural network parameters, proxy functions defined in Equations 10-13 can be used to approximate n_{AC}, n_{AU}, n_{IC}, and n_{IU}:

$$\begin{matrix}{n}_{AU} = {\sum }_{i ∈ \{ {\hat{y}}_{i} = {y}_{i} and {u}_{i} > {u}_{th} \}} {p}_{i} ⊙ tanh ( {u}_{i} ) & Equation 10 \\ {n}_{IC} = {\sum }_{i ∈ \{ {\hat{y}}_{i} \neq {y}_{i} and {u}_{i} \leq {u}_{th} \}} ( 1 - {p}_{i} ) ⊙ ( 1 - tanh ( {u}_{i} ) ) & Equation 11 \\ {n}_{A C} = {\sum }_{i ∈ \{ {\hat{y}}_{i} = {y}_{i} and {u}_{i} \leq {u}_{th} \}} {p}_{i} ⊙ ( 1 - tanh ( {u}_{i} ) ) & Equation 12 \\ {n}_{UI} = {\sum }_{i ∈ \{ {\hat{y}}_{i} \neq {y}_{i} and {u}_{i} > {u}_{th} \}} ( 1 - {p}_{i} ) ⊙ tanh ( {u}_{i} ) & Equation 13\end{matrix}$$

For example, a hyperbolic tangent function can be used to scale the uncertainty values between 0 and 1, such that tanh (uᵢ)∈[0,1]. The intuition behind these approximations is that the probability of the predicted class {pᵢ→1} when predictions are accurate and {pᵢ→0} when predictions are inaccurate. Furthermore, the scaled uncertainty {tanh (uᵢ)→0} when the predictions are certain and {tanh (uᵢ)→1} when the predictions are uncertain.

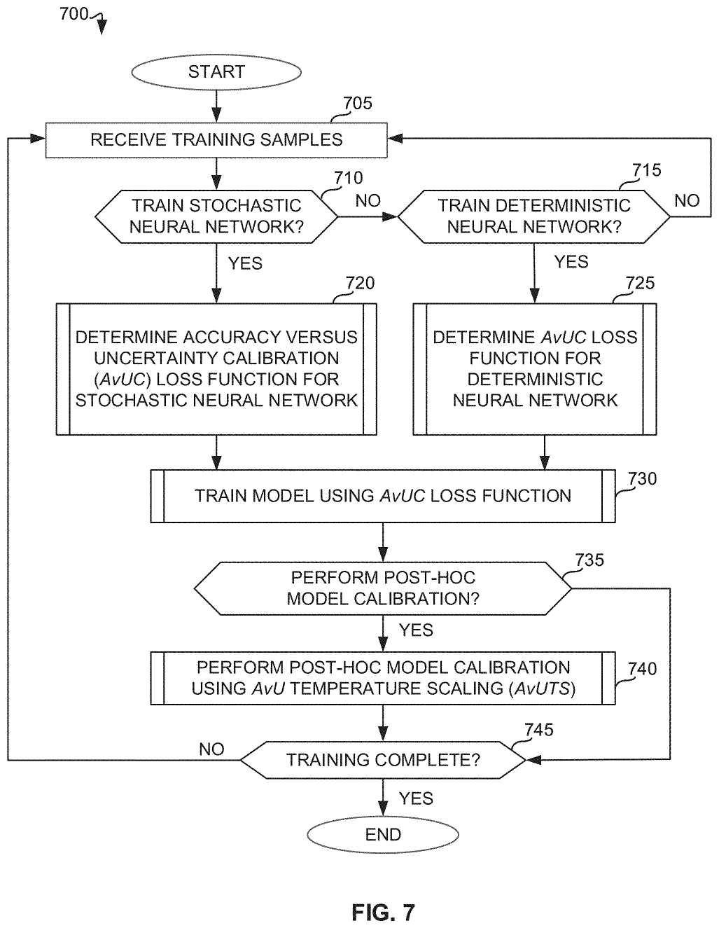

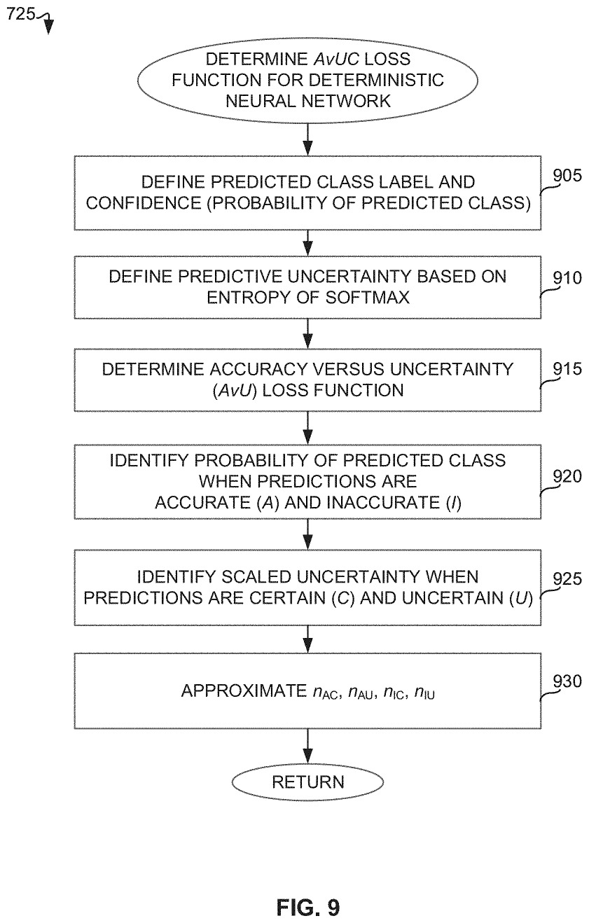

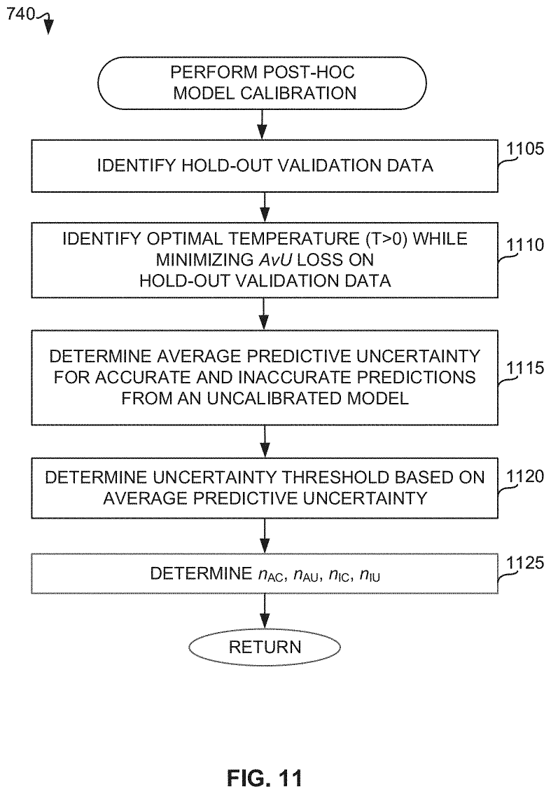

For example, under ideal conditions, thee proxy functions of Equations 10-13 can be equivalent to the indicator functions of Equations 5-8. The loss function of Equation 9 can be used with standard gradient descent optimization to enable the model to learn to provide well-calibrated uncertainties, in addition to improved prediction accuracy. Minimizing the loss function of Equation 9 is equivalent to maximizing the AvU metric 305 of FIG. 3. For example, the loss function of Equation 9 becomes zero when all accurate predictions are certain and inaccurate predictions are uncertain. In some examples, the interval of the AvU metric 305 and the interval of the AvU loss function can be different (e.g., AvU∈[0,1] and [symbol] _{AvU}∈[0, ∞). To obtain well-calibrated uncertainties and best model performance, the proposed AvU loss function of FIG. 9 can be used along with well-established optimization techniques (e.g., such as evidence lower bound loss, cross-entropy loss, focal loss, etc.), depending on the type of neural network (e.g., Bayesian or non-Bayesian) and/or classification task, as described in connection with FIGS. 7-10. Furthermore, as described in further detail in connection with FIG. 11, for post-hoc calibration the AvU loss can either be used as a stand-alone optimization objective or together with negative log likelihood loss (e.g., standard temperature scaling).

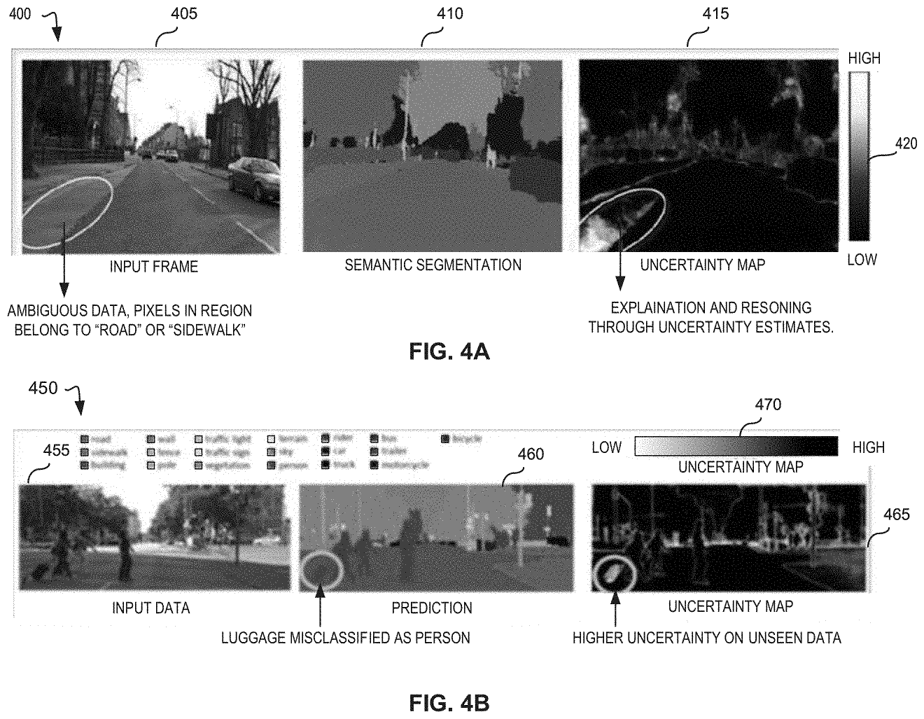

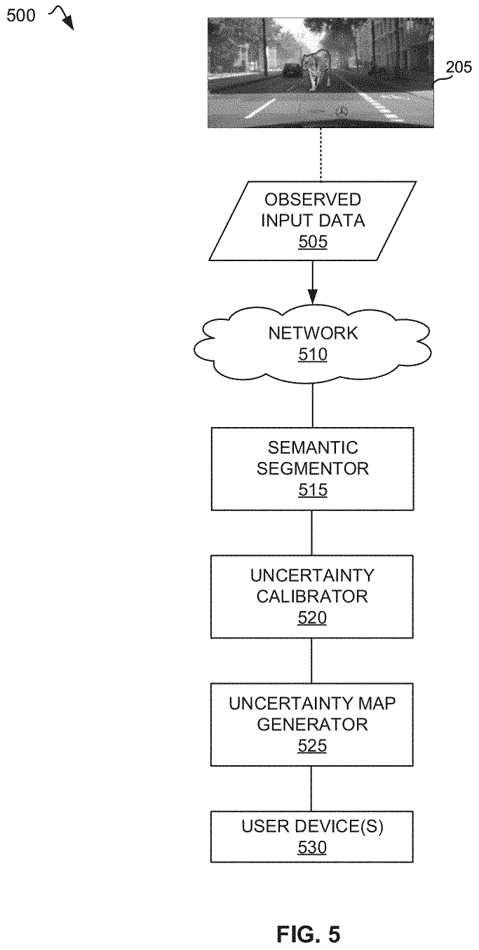

FIGS. 4A-4B illustrate example accuracy versus uncertainty quantifications 400, 450 used for improved decision-making in artificial intelligence (AI)-related applications in accordance with teachings of this disclosure. As described in more detail in connection with FIGS. 5-11, the AvU loss function defined in connection with FIG. 3 can be used to train a model to minimize AvU loss. FIGS. 4A-4B provide example illustrations of how reliable uncertainty estimation is helpful in trusting a model's predictions, including during presence of ambiguity in observed data as well as unseen data (out-of-distribution). For example, input images 405, 455 are provided with ambiguity in the observed data (e.g., pixels of a region of the image can be classified as either part of a road or part of a sidewalk in image 410 and/or as luggage or as a person in image 460, etc.). Example uncertainty maps 415, 465 can be used to distinguish areas of the input images 405, 455 that are subject to higher levels of uncertainty. In both examples, the uncertainty maps can include an example indicator 420, 470 of the level of uncertainty (e.g., low to high) associated with the predictions made by a given model. Over time, the model can be improved to reduce the level of uncertainty and increase the level of accuracy during classification.

FIG. 5 illustrates an example system 500 constructed in accordance with teachings of this disclosure and including an example uncertainty calibrator 520 to obtain well-calibrated uncertainty in deep neural networks. The system 500 includes an example image 205, an example observed data input 505, an example network 510, an example semantic segmentor 515, an example uncertainty calibrator 520, an example uncertainty map generator 525, and example user device(s) 530. The image 205 can be any image in a set of images provided to a neural network during training and/or deployment in the wild (e.g., via observed input data 505). In the example of FIG. 5, the image 205 corresponds to the image 205 of FIG. 2, showing a tiger on a road, as could be seen from the front of a vehicle. A well-trained model would be able to recognize the object in the form of a tiger as an actual tiger, instead of a person. Likewise, as described in connection with FIG. 2, any features that have a high level of uncertainty (e.g., interior versus edge features) would be indicated as having high uncertainty using uncertainty maps generated using the uncertainty map generator 525, as described in more detail below. In some examples, the image 205 can be provided to any type of deep neural network (DNN), such as a convolutional neural network (CNN), a recurrent neural network (RNN), and/or any other network relevant to image processing. In some examples, the image 205 can be any digital encoding of data for a particular data type (e.g., observed data input such as an image, audio, and/or video). For example, the image 205 can be a digital image made of pixels, such that each pixel is a discrete value representing an analog light waveform (e.g., a pixel value of 0 can represent black as a minimum intensity and a pixel value of 255 can represent white as a maximum intensity). In some examples, the image precision of image 205 can depend on how the image was captured, storage constraints, etc. As such, image processing performed using a DNN using images such as image 205 allows the DNN to classify the image (e.g., based on its primary content, etc.). In some examples, such image processing ca include scene classification, object detection and localization, semantic segmentation, and/or facial recognition. For example, image segmentation is shown in the example of FIGS. 4A-4B, where fine-grained depictions of regions of the image are shown, corresponding to different classification (e.g., pavement, road, person, etc.). Such image segmentation can be performed using the semantic segmentor 515, as described below in more detail.

The network 510 provides the observed input data 505 (e.g., image 205) to the semantic segmentor 515 for further processing. The network 510 may be implemented using any suitable wired and/or wireless network(s) including, for example, one or more data buses, one or more Local Area Networks (LANs), one or more wireless LANs, one or more cellular networks, the Internet, etc. In the examples disclosed herein, the network 510 permits collection of observed input data 505 (e.g., an image 205) observed in the wild during deployment and/or training data obtained during the network's training period. In some examples, the network 510 can be used by the user device(s) 530 to access results of the observed input data 505 processing (e.g., classification of objects, uncertainty mapping, segmentation views, etc.).

The semantic segmentor 515 labels each pixel of an image (e.g., image 205) with a corresponding class of what is being represented (e.g., dense prediction), such that each pixel can be categorized. Segmentation can be used for a variety of real-world applications, including in autonomous vehicles (e.g., real-time segmentation can occur as the vehicle is receiving observed input data 505) and medical image diagnostics (e.g., for augmentation of analyses performed by radiologists). In some examples, the semantic segmentor 515 receives testing data including ground truth target segmentation images (e.g., images that are already segmented with correct classifications of each pixel and/or image 205 region). As such, the predicted segmentation can be compared to the ground truth target for training purposes. In some examples, the semantic segmentor can include a pixel-wise cross entropy loss function to examine each pixel individually (e.g., to compare class predictions to an encoded target vector). However, cross entropy loss evaluates class predictions for each pixel vector individually and then averages over all pixels, thereby associating equal learning with each pixel in the image. However, various classes can have unbalanced representation in an image (e.g., image 205) such that training becomes dominated by the most prevalent class. As such, while cross entropy loss is commonly used for training neural networks in multi-class classification tasks, such models are readily overfitted while mainly focused on improving accuracy and are prone to over-confidence. As such, a differentiable accuracy versus uncertainty loss function for training neural networks is incorporated into the uncertainty calibrator 520 to allow the model to learn to provide well-calibrated uncertainties in addition to improved accuracy. The methods and apparatus disclosed herein are not limited to semantic segmentation and can be applied to any type of classification task (e.g., image classification, audio classification, two-dimensional and/or three-dimensional object detection, video, etc.).

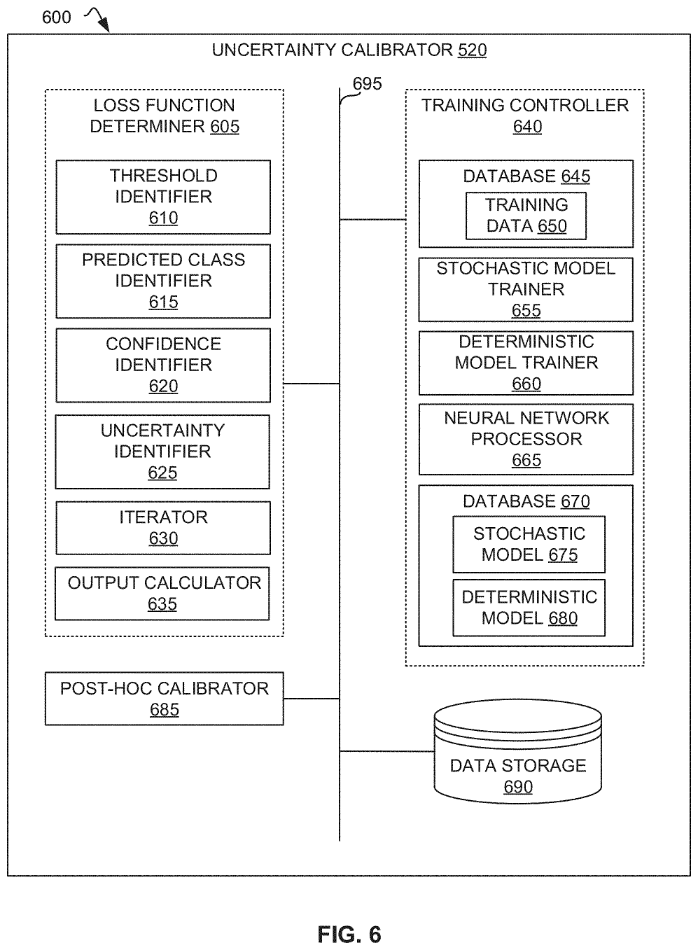

The uncertainty calibrator 520 identifies the loss function as described in connection with FIG. 3 using Equations 1-13. For example, once the loss function has been determined, the uncertainty calibrator 520 trains the model. For example, artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations. Initially, the uncertainty calibrator 520 can train the model to learn the uncertainty threshold required for calculating AvU loss, which is obtained through the mean of average predictive uncertainty for accurate and inaccurate predictions while training the model, as described in connection with FIG. 6. In some examples, the uncertainty calibrator 520 can be used to perform model-based experiments under data shift (e.g., at different image perturbations and/or intensity levels). As such, the uncertainty calibrator 520 can be used to train deep neural network classifiers (e.g., Bayesian and non-Bayesian) that result in models that are confident on accurate predictions and indicate high uncertainty when they are likely to be inaccurate. Specifically, the uncertainty calibrator 520 uses the differentiable AvU loss function of Equation 9 to train probabilistic deep neural networks, as well as for post-hoc calibration of the models. For example, the uncertainty calibrator 520 optimizes and computes the AvU metric 305 of FIG. 3 for a mini-batch of data samples while training the model. As such, the model calibration can be improved by introducing AvU loss when training the classification networks, where AvU is utilized in the context of optimization to obtain well calibrated uncertainties.

The uncertainty map generator 525 generates an uncertainty map (e.g., uncertainty map(s) 415, 465 of FIG. 4) to allow the model to communicate to a user (e.g., via user device(s) 530) the area(s) of image classification that are highly certain (e.g., edges of an object) versus areas of image classification that are more uncertain (e.g., internal features of the object), thereby providing an explanation of model prediction through uncertainty estimates (e.g., example visual uncertainty estimate 220 of FIG. 2). In some examples, the uncertainty map generator 525 can generate a percentage and/or confidence score associated with a given prediction. For example, a well-calibrated model should be confident about its predictions when it is accurate and indicate high uncertainty when making inaccurate predictions. In some examples, the uncertainty map generator 525 can provide pre-training and post-training images, and/or predictions generated with and/or without training using the loss function to allow a user to compare/contrast the predictions (e.g., based on training settings, etc.).

The user device(s) 530 can be stationary or portable computers, handheld computing devices, smart phones, Internet appliances, and/or any other type of device that may be connected to a network (e.g., the Internet). In the illustrated example of FIG. 5, the user device(s) 530 include a smartphone (e.g., an Apple® iPhone®, a Motorola™ Moto X™, a Nexus 5, an Android™ platform device, etc.) and a laptop computer. However, any other type(s) of device(s) may additionally or alternatively be used such as, for example, a tablet (e.g., an Apple® iPad™, a Motorola® Xoom™, etc.), a desktop computer, a camera, an Internet compatible television, a smart TV, etc. The user device(s) 530 of FIG. 5 are used to access (e.g., request, receive, render and/or present) information associated with a given model (e.g., an uncertainty map, a model prediction, etc.). In some examples, the user device(s) 530 can be any device(s) that can be used during and/or in conjunction with real-world deployment of the trained model (e.g., device(s) of an autonomous vehicle, diagnostic medical imaging equipment, etc.).

FIG. 6 is a block diagram 600 of the example uncertainty calibrator 520 of FIG. 5, including an example loss function determiner 605, an example training controller 640, an example post-hoc calibrator 685, and an example data storage 690, constructed in accordance with teachings of this disclosure. The loss function determiner 605 includes an example threshold identifier 610, an example predicted class identifier 615, an example confidence identifier 620, an example uncertainty identifier 625, an example iterator 630, and an example output calculator 635.

The threshold identifier 610 identifies an uncertainty threshold (e.g., as defined using uₜₕ in connection with Equations 5-8 and/or Equations 10-13). For example, the uncertainty threshold uₜₕ can be used to determine the level of certainty with a given model prediction. For example, a certain prediction can correspond to an uncertainty being less than the uncertainty threshold while an uncertain prediction can correspond to an uncertainty being greater or equal to the uncertainty threshold (e.g., uncertain prediction). In connection with Equations 5-8 and/or Equations 10-13, uᵢ>uₜₕ corresponds to an accurate but uncertain measure (AU) and/or an inaccurate and uncertain measure (IU). Likewise, uᵢ<uₜₕ corresponds to an inaccurate but certain measure (IC) and/or an accurate and certain measure (AC), as described in connection with FIG. 3. Initially, the uncertainty calibrator 520 trains a model to learn the uncertainty threshold uₜₕ required for calculating the AvU loss function of Equation 9. In some examples, the threshold identifier 610 determines uₜₕ while training the model, based on a mean of average predictive uncertainty for accurate and inaccurate predictions. Means for determining an uncertainty threshold during an initial model training epoch (e.g., using ELBO loss) can be implemented by the threshold identifier 610. Means for determining an uncertainty threshold can include determining the uncertainty threshold based on a predictive uncertainty mean for accurate predictions or inaccurate predictions.

The predicted class identifier 615 determines the predicted class label (ŷᵢ). As previously described in connection with FIG. 3, the predicted class label can be defined as ŷᵢ=arg max_{y∈} [symbol] pᵢ(y|xᵢ, w). In some examples, the predicted class identifier 615 predicts the class associated with an image 205 and/or pixel of the image 205 (e.g., based on image segmentation performed by the semantic segmentor 515). In some examples, the predicted class identifier 615 is used to define the indicator functions of Equations 5-8. For example, ŷᵢ=yᵢ corresponds to accurate and certain (AC) and/or accurate and uncertain (AU) measures, while yᵢ≠yᵢ corresponds to inaccurate and certain (IC) and/or inaccurate and uncertain (IU) measures.

The confidence identifier 620 determines a confidence (pᵢ) metric (e.g., probability of predicted class ŷᵢ), which can be defined as pᵢ=max_{y∈} [symbol] pᵢ(y|xᵢ, w). As previously described, the probability of predicted class {pᵢ→1} when predictions are accurate and {pᵢ→0} when predictions are inaccurate. The loss function determiner 605 uses the confidence determiner 620 to incorporate confidence into the loss function of Equation 9, as described in connection with Equations 10-13.

The uncertainty identifier 625 determines a predictive uncertainty estimate (uᵢ) for the model prediction, which can be defined as uᵢ=−Σ_{y∈} [symbol] pᵢ(y|xᵢ, w) log pᵢ(y|xᵢ, w). In some examples, the uncertainty identifier 625 scales the uncertainty values between 0 and 1 using a hyperbolic tangent function, such that tanh (uᵢ)∈[0,1]. As such, the scaled uncertainty {tanh (uᵢ)→0} when the predictions are certain and {tanh (uᵢ)→1} when the predictions are uncertain. The loss function determiner 604 uses the uncertainty identifier 625 to incorporate the predictive uncertainty estimate into the loss function of Equation 9, as described in connection with Equations 10-13.

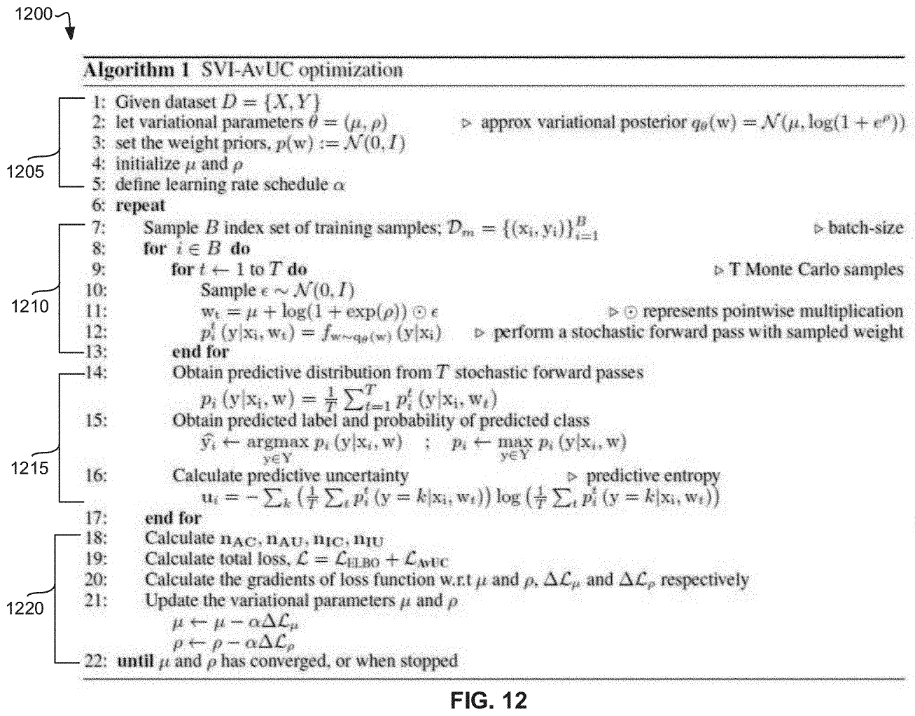

The iterator 630 iterates through a group of randomly sampled examples (e.g., mini-batches) during training, as described in connection with an algorithm of FIG. 12. For example, the uncertainty calibrator 520 defines a dataset (D) during training, such that the dataset includes N examples, according to Equation 1. In some examples, the dataset D is partitioned into M mini-batches, as described in connection with Equation 2. As such, the iterator 630 processes the group of mini-batches per iteration. For example, each batch can contain B=N/M examples, as previously defined using Equation 3. In some examples, the iterator 630 performs a stochastic forward pass (e.g., moving forward through the network), such that the defined equations are iteratively used for calculations in each layer of the network. In some examples, the iterator 630 performs the passes, such that each pass uses a defined batch size of examples. As such, every time a batch of data (e.g., mini-batch) is passed through a neural network, an iteration is completed. In some examples, the iterator 630 performs a forward pass and/or a backward pass. For example, the iterator 630 performs a forward pass to obtain values from network output layers based on input data, such that a loss function can be calculated from the output values. In some examples, a backward pass can be performed to count changes in weights, such that the computation is performed from the last later of the network backwards to the first layer of the network.

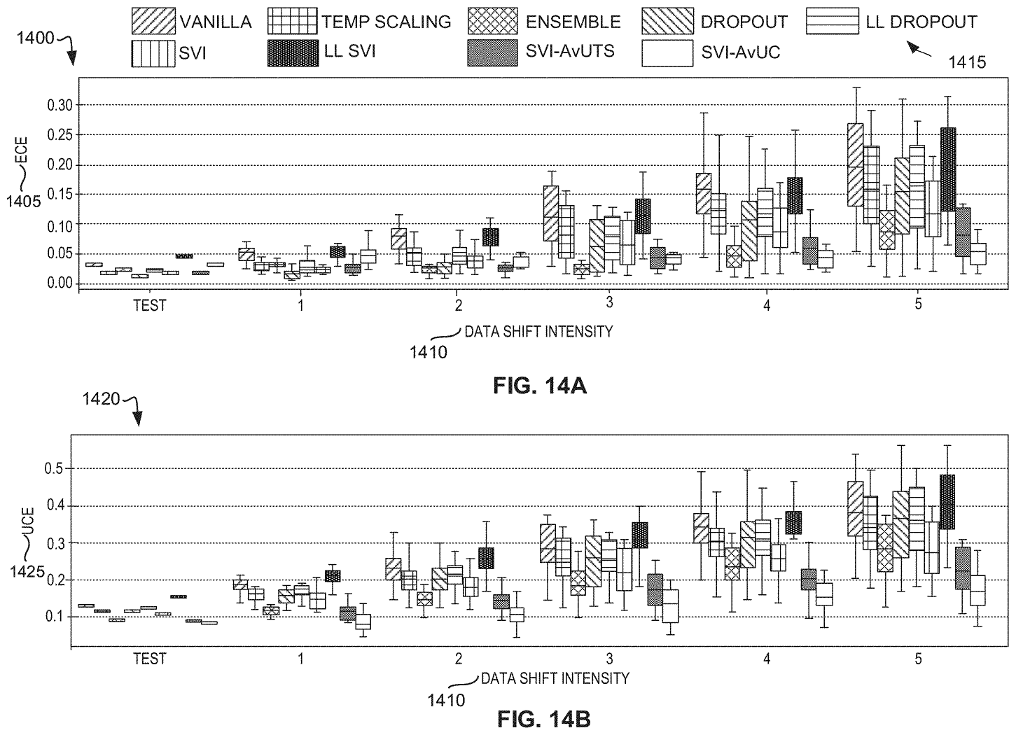

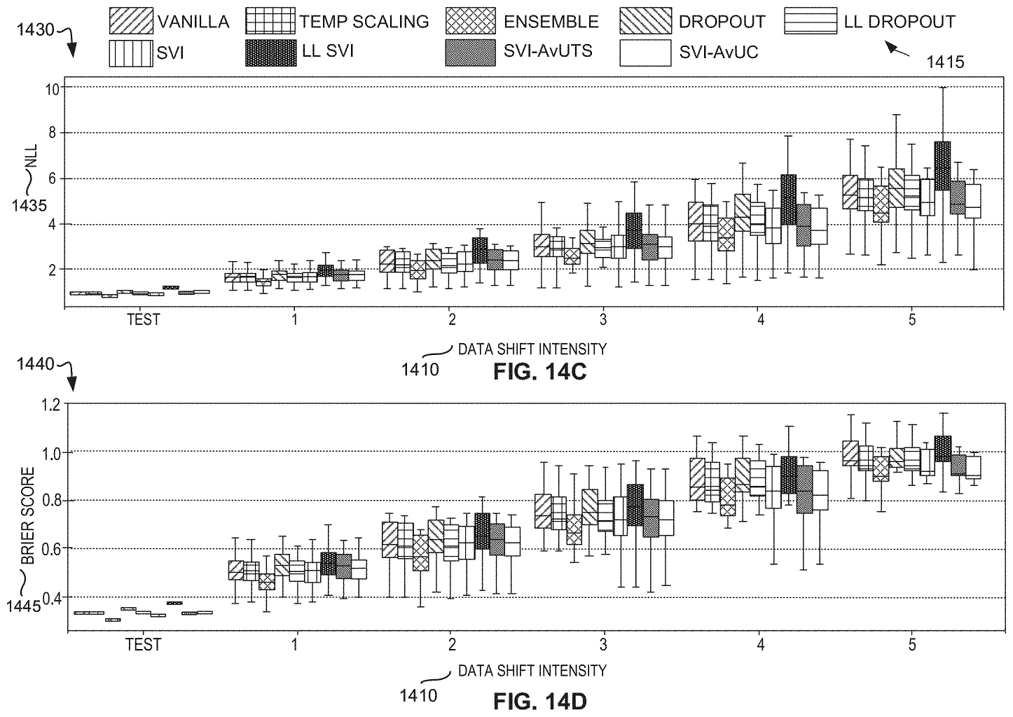

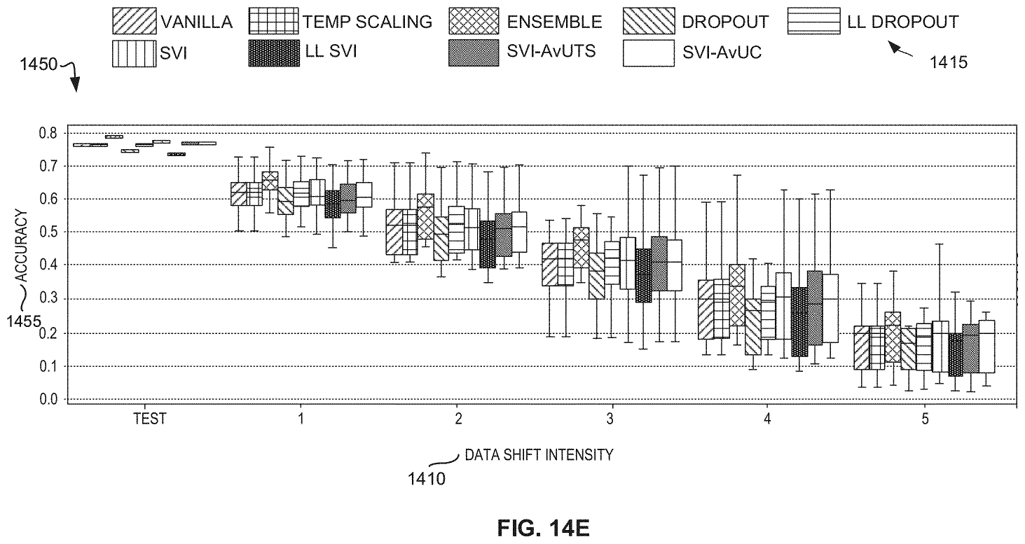

The output calculator 635 identifies output resulting from any iterations performed by the iterator 630, as generated by the neural network (e.g., a given layer of the neural network). In some examples, the output calculator 635 determines any outputs generated during loss function optimization (e.g., predictive distribution obtained from stochastic forward passes, predicted class label, probability of predicted class, predictive uncertainty, number of accurate and certain (nAC) predictions, number of inaccurate and uncertain (nIU) predictions, number of accurate and uncertain (nAU) predictions, number of inaccurate and certain (nIC) predictions, total loss output calculation, loss function gradient calculations, etc.). In some examples, the output calculator 635 can include output generated during empirical evaluations of large-scale image classification tasks under distributional shift. For example, the output calculator 635 can provide data for model calibration error with respect to confidence (ECE), model calibration error with respect to predictive uncertainty (UCE) based on data shift intensity, as well as any other assessment performed during model calibration evaluation, model confidence and uncertainty evaluation, distributional shift detection, and/or monitoring of metrics and loss functions during training, as described in connection with FIGS. 14-30. Overall, means for determining a differentiable accuracy versus uncertainty loss function for a machine learning model can be implemented by the loss function determiner 605.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process. Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using training algorithms such as a stochastic gradient descent. However, any other training algorithm may additionally or alternatively be used. In examples disclosed herein, training can be performed based on early stopping principles in which training continues until the model(s) stop improving. In examples disclosed herein, training can be performed remotely or locally. In some examples, training may initially be performed remotely. Further training (e.g., retraining) may be performed locally based on data generated as a result of execution of the models. Training is performed using hyperparameters that control how the learning is performed (e.g., a learning rate, a number of layers to be used in the machine learning model, etc.). In examples disclosed herein, hyperparameters that control complexity of the model(s), performance, duration, and/or training procedure(s) are used. Such hyperparameters are selected by, for example, random searching and/or prior knowledge. In some examples re-training may be performed. Such re-training may be performed in response to new input datasets, drift in the model performance, and/or updates to model criteria and system specifications.

Training is performed using training data. In examples disclosed herein, the training data originates from previously generated images (e.g., image data with different resolutions, images with different numbers of subjects captured therein, etc.). If supervised training is used, the training data is labeled. In some examples, the training data is sub-divided such that a portion of the data is used for validation purposes. Once training is complete, the model(s) are stored in one or more databases (e.g., database 670 of FIG. 6).

Once trained, the deployed model(s) may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model(s) may be captured and provided as feedback. By analyzing the feedback, an accuracy of the deployed model(s) can be determined. If the feedback indicates that the accuracy of the deployed model(s) is less than a threshold or other criterion, training of an updated model can be triggered using the feedback and an updated training data set, hyperparameters, etc., to generate an updated, deployed model(s).

Once the loss function has been determined using the loss function determiner 605, the training controller 640 trains the model to minimize AvU loss. The training controller 640 includes an example first database 645, an example stochastic model trainer 655, an example deterministic model trainer 660, an example neural network processor 665, and an example second database 670.

The first database 645 includes example training data 650. In the example of FIG. 6, the training data can be any data used for model training (e.g., images, audios, videos, etc.). In some examples, the training data can include ground truth data (e.g., segmented images) to allow for a comparison between a prediction made by the model and the ground truth data. The stochastic model trainer 655 and/or the deterministic model trainer 660 trains the neural network implemented by the neural network processor 665 using the training data 650. In the example of FIG. 6, the training controller 640 instructs the stochastic model trainer 655 and/or the deterministic model trainer 660 to perform training of the neural network based on training data 650. Means for training a machine learning model, the training including performing an uncertainty calibration of the machine learning model using the loss function, can be implemented by the training controller 640. Means for training a machine learning model can include training the model using the determined loss function in combination with negative evidence lower bound (ELBO) loss. Additionally, means for training a machine learning model can include means for training a stochastic model or means for training a deterministic model.

In the example of FIG. 6, the training data 650 used by the stochastic model trainer 655 and/or the deterministic model trainer 660 to train the neural network is stored in a database 645. The example database 645 of the illustrated example of FIG. 6 is implemented by any memory, storage device and/or storage disc for storing data such as, for example, flash memory, magnetic media, optical media, etc. Furthermore, the data stored in the example database 645 may be in any data format such as, for example, binary data, comma delimited data, tab delimited data, structured query language (SQL) structures, image data, etc. While the illustrated example database 645 is illustrated as a single element, the database 645 and/or any other data storage elements described herein may be implemented by any number and/or type(s) of memories.

The stochastic model trainer 655 trains the model according to an example algorithm 1200 described in connection with FIG. 12. For example, the stochastic model trainer 655 can use mean-field stochastic variational inference (SVI) during training. Bayesian inference algorithms can require a complete pass over data in each iteration and may not scale well, while some Bayesian inference algorithms such as SVI require only a small number of passes and can operate in the single-pass or streaming settings. For example, SVI provides a general framework for scalable inference based on a mean-field and/or a stochastic gradient optimization. More specifically, Bayesian deep neural networks provide a probabilistic interpretation of deep learning models by learning probability distributions over the neural network weights, as described in connection with FIG. 12. For example, the stochastic model trainer 655 uses the total loss function [symbol] as defined in accordance with Equation 14:

$$ℒ := - {𝔼}_{q θ ( w )} [ log p ( y \text{\textbar} x , w ) ] + KL [ q θ ( w ) \text{\textbar \textbar} p ( w ) ] + β log ( 1 + \frac{{n}_{AU} + {n}_{IC}}{{n}_{A C} + {n}_{IU}} ) \\ ℒ := expected negative log likelihood + Kullback\_Leibler divergence + β ( {ℒ}_{AvU} ( AvU loss ) ) \\ ℒ := {ℒ}_{ELBO} ( negative ELBO ) + β ( {ℒ}_{AvU} ( AvU loss ) ) \qquad Equation 14$$

In the example of Equation 14, the total loss function includes AvU loss of Equation 9 in combination with negative evidence lower bound (ELBO). ELBO is used during optimization given that it can be computed without access to a true posterior, depending on the choice of distribution, as described in more detail in connection with FIG. 12. In the example of Equation 14, β is a hyperparameter for relative weighting of AvU loss with respect to ELBO. While there are two types of uncertainties that constitutes predictive uncertainty of models (e.g., aleatoric uncertainty and epistemic uncertainty), probabilistic DNNs can quantify both aleatoric and epistemic uncertainties, but deterministic DNNs can capture only aleatoric uncertainty. As such, various metrics have been proposed to quantify these uncertainties in classification tasks. In the examples disclosed herein, aleatoric and/or epistemic uncertainties can be used for computing the AvU loss function.

The stochastic model trainer 655 uses the loss function of Equation 14 during training, as shown in algorithm 1200 of FIG. 12, which describes the implementation of the SVI-AvUC method (e.g., Stochastic Variational Inference using Accuracy versus Uncertainty Calibration). In the example of Equation 14, [symbol] _{ELBO}(negative ELBO) is represented by an equation for expected negative log likelihood combined with an equation for Kullback-Leibler divergence, while the equation for AvU loss function of Equation 9 is multiplied by the hyperparameter β, thereby yielding the full Equation 14. In some examples, the stochastic model trainer 655 trains the model using ELBO loss in the initial few epochs to determine the uncertainty threshold (uₜₕ) required for AvU loss (e.g., using the threshold identifier 610). As described in connection with the threshold identifier 610, the threshold can be obtained from an average of predictive uncertainty mean for accurate and inaccurate predictions on the training data from initial epochs. In some examples, the stochastic model trainer 655 can compute area under AvU (AU-AvU) to compute AvU at various uncertainty thresholds. In some examples, use of AU-AvU can result in increased compute requirements during the training phase, but no difference in compute during the inference phase. Means for training a stochastic model can be implemented using the stochastic model trainer 655. Means for training a stochastic model can include training a stochastic neural network using the determined loss function, the loss function based on a predictive distribution determined from stochastic forward passes during training.

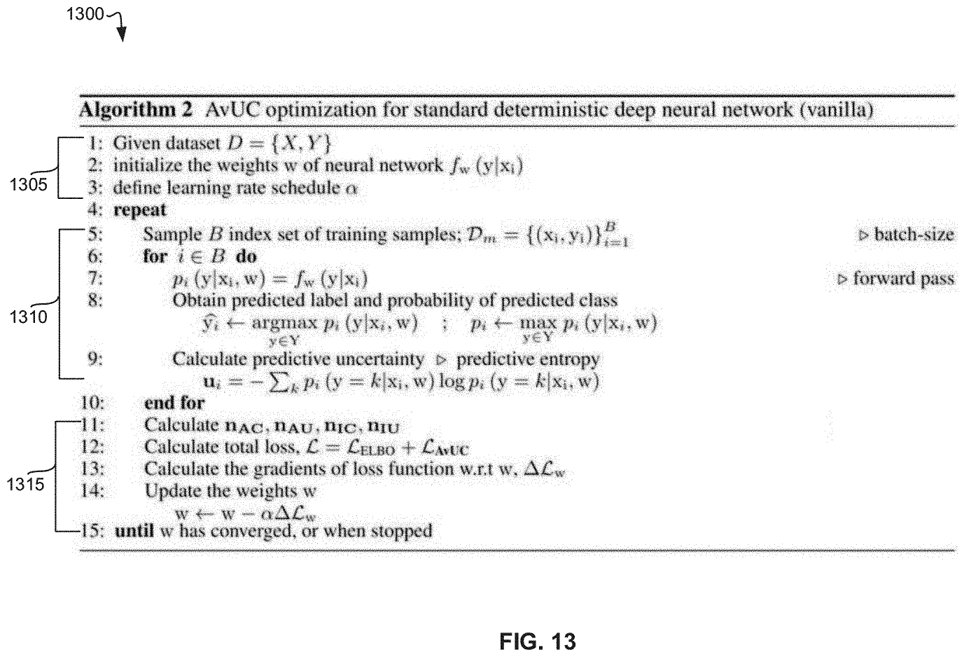

The deterministic model trainer 660 trains the model according to an example algorithm 1300 described in connection with FIG. 13. For example, the deterministic model trainer 660 applies the total loss function of Equation 14 to a standard deterministic deep neural network classifier. In some examples, the deterministic model trainer 660 uses entropy of softmax (e.g., cross-entropy loss) as the predictive uncertainty measure. For example, the softmax classifier can be a linear classifier that uses the cross-entropy loss function (e.g., the cross-entropy loss function gradient can be used to determine how the softmax classifier should update its weights when using optimizations such as gradient descent). As such, the softmax function can be used to output a probability distribution that can be used for purposes of probabilistic interpretation in classification-based tasks. Given an output of probabilistic distribution, the deterministic model trainer 660 can use the cross entropy loss in neural networks with a softmax activation in one or more layers of the network, such that the cross entropy indicates the distance between what the model predicts the output distribution should be and the original distribution. Means for training a deterministic model can be implemented using the deterministic model trainer 660. For example, means for training a deterministic model can include training a deterministic neural network using the determined loss function, the loss function based on a predictive uncertainty determined using entropy of softmax.

The neural network processor 665 implements the neural network(s) trained by the stochastic model trainer 655 and/or the deterministic model trainer 660 using the training data 650. In the examples disclosed herein, the neural network processor 665 permits the training and/or implementation of the neural network(s), thereby allowing for any mathematical operations used in the neural network(s) (e.g., matrix multiplications, convolutions, etc.). In some examples, the neural network processor 665 can adjust performance based on the needs of the neural network(s). In some examples, the neural network processor 665 permits parallel computing, such that the overall network has higher bandwidth and lower latency.

The second database 670 includes example stochastic model 675 and example deterministic model 680. In the example of FIG. 6, the stochastic model 675 includes the model generated based on training performed by the stochastic model trainer 655, while the deterministic model 680 is the model generated based on training performed by the deterministic model trainer 660. The second database 670 of the illustrated example of FIG. 6 is implemented by any memory, storage device and/or storage disc for storing data such as, for example, flash memory, magnetic media, optical media, etc. Furthermore, the data stored in the second database 670 may be in any data format such as, for example, binary data, comma delimited data, tab delimited data, structured query language (SQL) structures, image data, etc. While the illustrated second database 670 is illustrated as a single element, the second database 670 and/or any other data storage elements described herein may be implemented by any number and/or type(s) of memories.

The post-hoc calibrator 685 performs post-hoc model calibration. For example, the post-hoc calibrator 685 performs post-hoc uncertainty calibration for pre-trained model by extending a temperature scaling methodology. Temperature scaling is a post-processing technique used to restore network calibration without requiring additional training data. In examples disclosed herein, the post-hoc calibrator 685 optimizes AvU loss instead of negative log likelihood (NLL) loss. While NLL loss, also known as cross entropy loss, is commonly used for training neural networks in multi-class classification tasks, such models are readily overfitted to NLL loss while mainly focused on improving accuracy and are prone to over-confidence. As described herein, the post-hoc calibrator 685 implements a post-hoc model calibration with AvU temperature scaling (AvUTS), such that when applied to pre-trained SVI model(s), the method is referred to herein as SVI-AvUTS. For example, post-hoc calibrator 685 identifies the optimal temperature (e.g., T>0) while minimizing the AvU loss on a hold-out validation set (e.g., equivalently maximizing an AvU measure on hold-out validation data, the same data from which a temperature value is learned). In some examples, the uncertainty threshold required for calculating n_{AC}, n_{AU}, n_{IC}, and n_{IU} is obtained by determining the average predictive uncertainty for accurate and inaccurate predictions from the uncalibrated model on the hold-out validation data D_{V}, as shown using Equation 15 below, including the uncertainty threshold (uₜₕ):

$${𝒟}_{V} = {\{ ( {x}_{V} , {y}_{V} ) \}}_{v = 1}^{V} , {u}_{th} = ( \frac{{\overline{u}}_{( {\hat{y}}_{v} = {y}_{v} )} + {\overline{u}}_{( {\hat{y}}_{v} \neq {y}_{v} )}}{2} ) \qquad Equation 15$$

Means for optimizing the loss function using temperature scaling to improve the uncertainty calibration of the trained machine learning model under distributional shift can be implemented using the post-hoc calibrator 685. For example, means for optimizing the loss function can include identifying an optimal temperature while minimizing the loss function on hold-out validation data.

The data storage 690 can be used to store any information associated with the loss function determiner 605, the training controller 640, and/or the post-hoc calibrator 685. For example, the database 740 can store data associated with the uncertainty calibrator 520 (e.g., uncertainty threshold determination, predicted class identification, confidence determination, uncertainty calculation, iteration results, etc.). The example data storage 690 of the illustrated example of FIG. 6 can be implemented by any memory, storage device and/or storage disc for storing data such as flash memory, magnetic media, optical media, etc. Furthermore, the data stored in the example data storage 690 can be in any data format such as binary data, comma delimited data, tab delimited data, structured query language (SQL) structures, image data, etc.

While an example manner of implementing the uncertainty calibrator 520 of FIG. 3 is illustrated in FIGS. 5-6, one or more of the elements, processes and/or devices illustrated in FIG. 5-6 may be combined, divided, re-arranged, omitted, eliminated and/or implemented in any other way. Further, the example loss function determiner 605, the example training controller 640, the example post-hoc calibrator 685, and/or, more generally, the example uncertainty calibrator 520 of FIG. 6 may be implemented by hardware, software, firmware and/or any combination of hardware, software and/or firmware. Thus, for example, any of the example loss function determiner 605, the example training controller 640, the example post-hoc calibrator 685, and/or, more generally, the example uncertainty calibrator 520 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example loss function determiner 605, the example training controller 640 and/or the example post-hoc calibrator 685 is/are hereby expressly defined to include a non-transitory computer readable storage device or storage disk such as a memory, a digital versatile disk (DVD), a compact disk (CD), a Blu-ray disk, etc. including the software and/or firmware. Further still, the example uncertainty calibrator 520 of FIG. 6 may include one or more elements, processes and/or devices in addition to, or instead of, those illustrated in FIG. 6, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

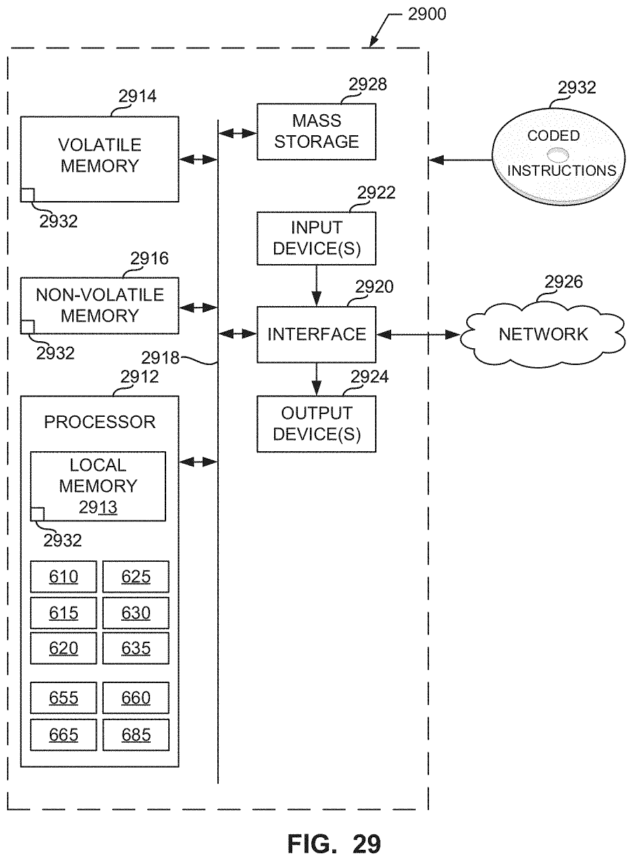

A flowchart representative of example hardware logic, machine readable instructions, hardware implemented state machines, and/or any combination thereof for implementing the uncertainty calibrator 520 of FIG. 6 is shown in FIGS. 7-11. The machine readable instructions may be one or more executable programs or portion(s) of an executable program for execution by a computer processor and/or processor circuitry, such as the processor 2912 shown in the example processor platform 3000 discussed below in connection with FIG. 29. The program may be embodied in software stored on a non-transitory computer readable storage medium such as a CD-ROM, a floppy disk, a hard drive, a DVD, a Blu-ray disk, or a memory associated with the processor 2912, but the entire program and/or parts thereof could alternatively be executed by a device other than the processor 2912 and/or embodied in firmware or dedicated hardware. Further, although the example program is described with reference to the flowcharts illustrated in FIG. 7-11, many other methods of implementing the example uncertainty calibrator 520 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 7-11 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 7 is a flowchart representative of example machine readable instructions 700 which may be executed to implement the example uncertainty calibrator 520 of FIG. 6. In the example of FIG. 7, the uncertainty calibrator 520 receives training samples (block 705). In some examples, the training samples can include image(s) (e.g., image 205 of FIGS. 2 and/or 5), video(s), and/or audio(s). In some examples, the training images can include any other type of observed input data 505 that is fed into the uncertainty calibrator 520. In some examples, the training data received by the uncertainty calibrator 520 can be based on the type of real-world application(s) the model is being trained for and/or the type of environment(s) that the system can be deployed to in the wild (e.g., models to be used in autonomous vehicles can receive training data that includes road-based images, whereas models to be used in medical image diagnosis can receive data that includes radiological images, etc.). The uncertainty calibrator 520 determines whether to train a stochastic neural network (block 710) and/or a deterministic neural network (block 715). For example, the uncertainty calibrator 520 uses the stochastic model trainer 655 to train a stochastic neural network and/or the deterministic model trainer 660 to train the deterministic neural network. In some examples, the uncertainty calibrator 520 determines whether to train using the stochastic model trainer 655 and/or the deterministic model trainer 660 based on whether a fixed input (e.g., same set of parameter values and/or initial conditions) leads to different outputs, thereby possessing inherent randomness (e.g., stochastic) and/or whether the output of the model is fully determined by the input parameter values and/or initial conditions (e.g., deterministic). For example, a deterministic algorithm provides the same outcome given the same output, whereas in a stochastic algorithm, the outputs can be different each time (e.g., uncertainty is associated with the output). For example, in a stochastic gradient descent model, parameters of the model are modified such that the training dataset can be shuffled randomly before each iteration by the iterator 630 of FIG. 6, resulting in different orders of updates to the model parameters while model weights can be initialized to a random starting point. If the uncertainty calibrator 520 does not determine whether to train a stochastic neural network (block 710) and/or a deterministic neural network (block 715), the uncertainty calibrator 520 continues to receive training samples (block 705) until a decision is made to proceed with training the stochastic neural network and/or the deterministic neural network.

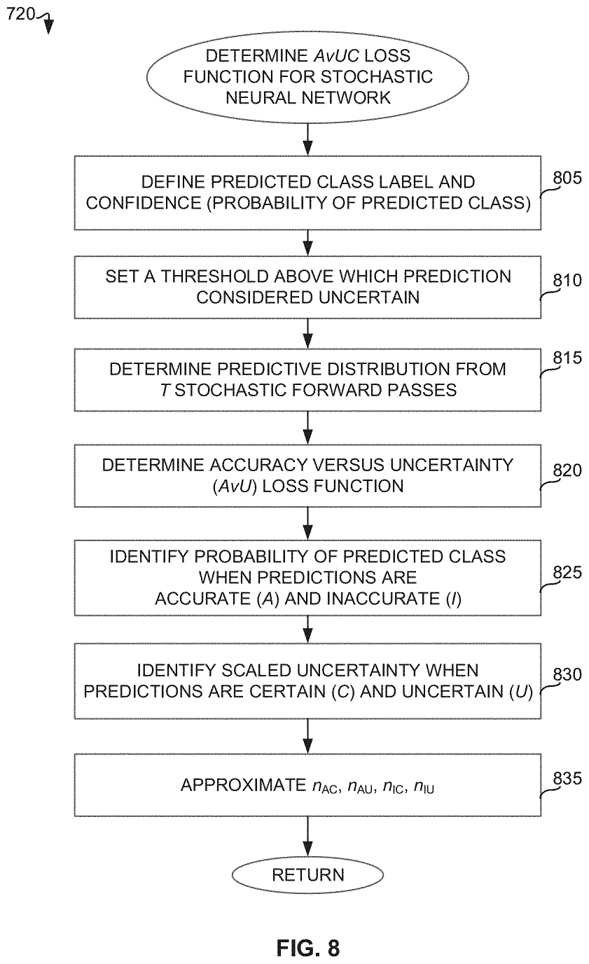

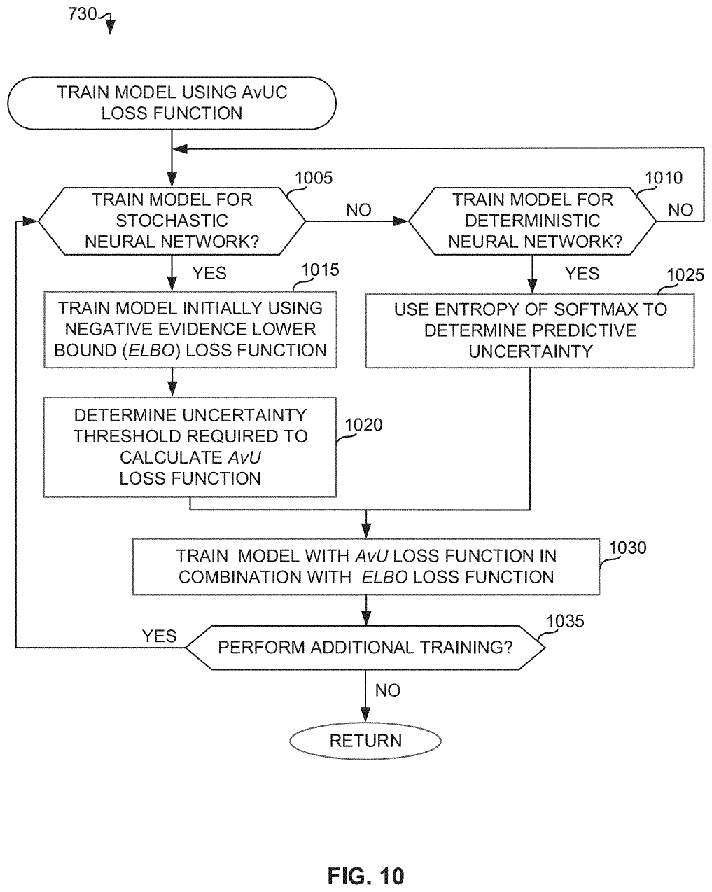

The uncertainty calibrator 520 trains a stochastic neural network using the stochastic model trainer 655 of FIG. 6. For example, the uncertainty calibrator 520 determines the accuracy versus uncertainty calibration (AvUC) loss function for the stochastic neural network (block 720). As described in connection with FIG. 8, the loss function determiner 605 is used to determine parameters such as the predicted class label, confidence, uncertainty threshold, predictive distribution, and/or any other parameters and/or variables needed to calculate the loss function and/or obtain the number of accurate and uncertain, accurate and certain, inaccurate and uncertain, and/or inaccurate and certain predictions for the stochastic neural network. Likewise, the uncertainty calibrator 520 determines the accuracy versus uncertainty calibration (AvUC) loss function for the deterministic neural network (block 725). As described in connection with FIG. 9, the loss function determiner 605 is used to determine parameters such as the predicted class label, confidence, predictive uncertainty, and/or any other parameters and/or variables needed to calculate the loss function and/or obtain the number of accurate and uncertain, accurate and certain, inaccurate and uncertain, and/or inaccurate and certain predictions for the deterministic neural network. Once loss functions have been determined and/or a training algorithm using the loss function has been developed for the deterministic and/or the stochastic neural network(s) (e.g., algorithms 1200, 1300 of FIGS. 12-13), the training controller 640 trains the model(s) using the stochastic model trainer 655 and/or the deterministic model trainer 660 using the loss function(s) (block 730), as described in connection with FIG. 10. The training controller 640 can store the trained models (e.g., stochastic model 675 and/or deterministic model 680) in the database 670 of FIG. 6, to be implemented by the neural network processor 665. In some examples, the model(s) can be trained in combination with the negative evidence lower bound (ELBO) loss function, as described in connection with Equation 14.

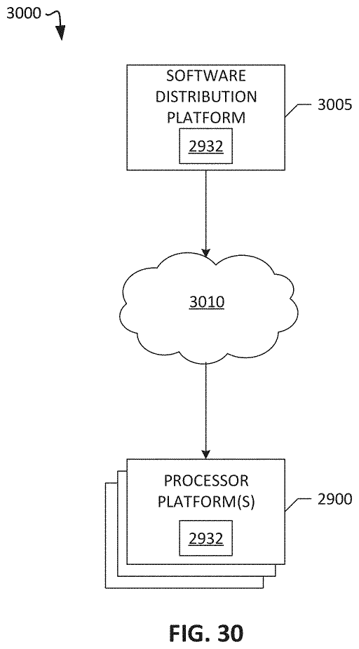

In some examples, the post-hoc calibrator 685 performs post-hoc model calibration once the stochastic and/or deterministic model(s) 675, 680 have been trained using the stochastic model trainer 655 and/or the deterministic model trainer 660. For example, a user can determine whether to proceed with post-hoc model calibration (e.g., via user device(s) 530 of FIG. 5) based on whether additional model calibration is required (e.g., for improved accuracy) (block 735). For example, the post-hoc calibrator 685 can use temperature scaling for the post-hoc calibration (block 740), as described in more detail in connection with FIG. 11. In some examples, the post-hoc calibrator 685 can evaluate AvUTS (e.g., AvU temperature scaling) by performing post-hoc calibration on deep neural network(s) with accuracy versus uncertainty calibration (AvUC) loss and compare the results when using conventional temperature scaling that optimizes negative log-likelihood loss (NLL). For example, a well-calibrated model should provide lower calibration errors even at increased levels of data shift. As such, the post-hoc calibrator 685 can be used to obtain significantly lower model calibration errors with increased distributional shift intensity while also providing comparable accuracy, as shown in connection with FIGS. 30A-30C. In some examples, the post-hoc model calibration with AvUTS can also be performed on a pretrained model, which was not trained using the AvUC loss function. In some examples, the trained model(s) 675, 680 can proceed to post-hoc model calibration to ensure that the model is well-calibrated. However, if the post-hoc model calibration is not needed and/or has been completed, the uncertainty calibrator 520 and/or the training controller 640 determine(s) whether the training is complete (block 745). For example, depending on the model accuracy and/or uncertainty output(s), the training can continue with additional training samples received (block 705) as more samples become available and/or the sample(s) change over time based on the expected deployment environment(s) for the developed models. Once training has been completed, the model(s) 675, 680 can be deployed in the wild (e.g., in an autonomous vehicle, in connection with medical image diagnostic equipment, etc.) and/or re-trained based on the model performance in the environment of interest.

FIG. 8 is a flowchart representative of example machine readable instructions 720 which may be executed to implement elements of the example uncertainty calibrator 520 of FIG. 6, the flowchart representative of instructions used to determine an accuracy versus uncertainty (AvUC) loss function for a stochastic neural network. In the example of FIG. 8, the loss function determiner 605 determines parameters associated with the stochastic neural network that are needed to develop the loss function of Equation 14, to be used in training the stochastic model 675 (e.g., as described in connection with algorithm 1200 of FIG. 12). For example, the predicted class identifier 615 defines the predicted class label yᵢ (e.g., yᵢ=arg max_{y∈} [symbol] pᵢ(y|xᵢ, w), where pᵢ (y|xᵢ, w) represents output from the neural network) and/or the confidence identifier 620 defines the confidence (e.g., probability of predicted class, pᵢ) (block 805). The threshold identifier 610 sets a threshold (uₜₕ) above which prediction(s) are considered uncertain (block 810). For example, the predictive uncertainty uᵢ (e.g., uᵢ=−Σ_{y∈} [symbol] pᵢ(y|xᵢ, w) log pᵢ(y|xᵢ, w)) can be compared to the threshold to determine whether a certain prediction is accurate but uncertain (AU) and/or inaccurate and uncertain (IU) (e.g., using uᵢ>uₜₕ). Likewise, predictive uncertainty uᵢ can be compared to the threshold to determine whether a certain prediction is inaccurate but certain (IC) and/or accurate and certain (AC) (e.g., using uᵢ≤uₜₕ). In some examples, the threshold identifier 610 determines uₜₕ while training the model, based on a mean of average predictive uncertainty for accurate and inaccurate predictions.

The loss function determiner 605 determines predictive distribution from T stochastic forward passes (block 815). For example, predictive distribution can be obtained from T stochastic forward passes (e.g., Monte Carlo samples), in accordance with Equation 4. In some examples, the loss function determiner 605 obtains predictive distribution through multiple stochastic forward passes on the network while sampling from the weight posteriors using Monte Carlo estimators based on Equation 15, where predictive distribution of the output y is given based on input x:

$${p}_{i} ( y \vert x , D ) \approx \frac{1}{T} {\sum }_{t = 1}^{T} p ( y \vert x , {w}_{t} ) , {w}_{t} \sim p ( w \text{\textbar} D ) \qquad Equation 15$$

Once the above parameters have been determined and/or defined (e.g., predicted class label, confidence, threshold, predictive distribution, etc.), the loss function determiner 605 defines the accuracy versus uncertainty (AvU) loss function of Equation 9 (block 820). Once the loss function has been defined, approximations for the number of accurate and certain predictions (n_{AC}), the number of accurate and uncertain predictions (n_{AU}), the number of inaccurate and certain predictions (n_{IC}), and/or the number of inaccurate and uncertain predictions (n_{IU}) can be determined based on setting the probability of predicted class (pᵢ) and/or identifying scaled uncertainty (uᵢ). The uncertainty identifier 625 determines probability of predicted class when predictions are accurate and inaccurate (block 825). For example, the uncertainty identifier 625 sets probability of the predicted class {pᵢ→1} when predictions are accurate and {pᵢ→0} when predictions are inaccurate. Furthermore, the predicted class identifier 615 identifies scaled uncertainty when predictions are certain and uncertain (block 830). For example, the predicted class identifier 615 uses a hyperbolic tangent function to scale the uncertainty values between 0 and 1, such that tanh (uᵢ)∈[0,1]. As such, the scaled uncertainty {tanh (uᵢ)→0} when the predictions are certain and {tanh (uᵢ)→1} when the predictions are uncertain. The loss function determiner 605 approximates n_{AU}, n_{AC}, n_{IC}, and/or n_{IU} based on Equations 10-13, described in connection with FIG. 3, once the above-listed parameters are identified and/or defined (block 835).

FIG. 9 is a flowchart representative of example machine readable instructions 725 which may be executed to implement elements of the example uncertainty calibrator 520 of FIG. 6, the flowchart representative of instructions used to determine an accuracy versus uncertainty (AvUC) loss function for a deterministic neural network. As previously described, a deterministic algorithm provides the same outcome given the same output, whereas in a stochastic algorithm, the outputs can be different each time (e.g., uncertainty is associated with the output). When determining the AvUC loss function for a deterministic neural network, the loss function determiner 605 uses predicted class identifier 615 to define the predicted class label (ŷᵢ) and/or the confidence identifier 620 to define the confidence (e.g., probability of predicted class, pᵢ) (block 905). The uncertainty identifier 625 defines predictive uncertainty based on entropy of softmax (block 910). For example, the uncertainty identifier 625 uses entropy of softmax (e.g., cross-entropy loss) as the predictive uncertainty measure. For example, the softmax classifier can be a linear classifier that uses the cross-entropy loss function (e.g., the cross-entropy loss function gradient can be used to determine how the softmax classifier should update its weights when using optimizations such as gradient descent). As such, the softmax function can be used to output a probability distribution. Given an output of probabilistic distribution, the deterministic model trainer 660 can use the cross-entropy loss in neural networks with a softmax activation in one or more layers of the network. Based on the defined parameters, the loss function determiner 605 determines the accuracy versus uncertainty (AvU) loss function of Equation 9 for the deterministic neural network (block 915). Likewise, the predicted class identifier 615 determines probability of predicted class (pᵢ) when predictions are accurate and inaccurate (block 920), while the uncertainty identifier 625 identifies scaled uncertainty (uᵢ) when predictions are certain and uncertain (block 925), as described in connection with FIG. 8 for the stochastic neural network. The loss function determiner 605 approximates n_{AU}, n_{AC}, n_{IC}, and/or n_{IU} based on Equations 10-13, described in connection with FIG. 3, once the above-listed parameters are identified and/or defined (block 930).

FIG. 10 is a flowchart representative of example machine readable instructions 730 which may be executed to implement elements of the example uncertainty calibrator 520 of FIG. 6, the flowchart representative of instructions used to train a machine learning model using the AvUC loss function(s) determined in FIG. 8 and/or FIG. 9. The training controller 640 determines whether training is needed for a stochastic neural network (block 1005) and/or a deterministic neural network (block 1010). In some examples, the determination is made based on the available data and/or whether a loss function was determined for a stochastic neural network and/or a deterministic neural network. When training a stochastic neural network, the training controller 640 uses the stochastic model trainer 655 to initially train the model using the negative evidence lower bound (ELBO) loss function (block 1015). For example, the stochastic model trainer 655 trains the model only with ELBO loss to learn the uncertainty threshold (uₜₕ) required for AvUC loss (block 1020). In some examples, the threshold identifier 610 obtains the threshold (uₜₕ) from an average of predictive uncertainty mean for accurate and inaccurate predictions on the training data from the initial epochs. Conversely, when the deterministic model trainer 660 trains the deterministic model, the deterministic model trainer 660 uses entropy of softmax to determine predictive uncertainty (uᵢ) (block 1025). However, the training controller 640 trains both models with the AvU loss function in combination with the ELBO loss function, as described in more detail in connection with algorithms 1200, 1300 of FIGS. 12-13. For example, ELBO loss (negative ELBO) can be minimized while training deep neural networks with stochastic gradient descent optimization. Once the training controller 640 completes training using the stochastic model trainer 655 (e.g., in accordance with algorithm 1200 of FIG. 12) and/or the deterministic model trainer 660 completes training using the deterministic model trainer 660 (e.g., in accordance with algorithm 1300 of FIG. 13), the models are stored as the stochastic model 675 and/or the deterministic model 680 in the second database 670 of FIG. 6. If the training controller 640 determines that additional training is required (block 1035), additional training is performed using the stochastic model trainer 655 and/or the deterministic model trainer 660.

FIG. 11 is a flowchart representative of example machine readable instructions 740 which may be executed to implement elements of the example uncertainty calibrator 520 of FIG. 6, the flowchart representative of instructions used to perform a post-hoc model calibration. As previously described in connection with FIG. 6, the post-hoc calibrator 685 performs post-hoc model calibration once the stochastic and/or deterministic model(s) 675, 680 have been trained using the stochastic model trainer 655 and/or the deterministic model trainer 660. For example, the post-hoc calibrator 685 can use temperature scaling for the post-hoc calibration based on AvUTS (e.g., AvU temperature scaling) to obtain significantly lower model calibration errors with increased distributional shift intensity while also providing comparable accuracy. The post-hoc calibrator 685 identifies hold-out validation data (block 1105). In some examples, the post-hoc calibrator 685 can identify the holdout validation data by splitting a given data set into a train and/or a test set, such that the model can be trained on the training set while the testing set is used to determine how well the model performs on unseen data. Once hold-out validation data is identified, the post-hoc calibrator 685 determines an optimal temperature for pretrained SVI model(s) by minimizing the accuracy versus uncertainty calibration (AvUC) loss on hold-out validation data (block 1110). In some examples, the post-hoc calibrator 685 uses the hold-out validation data to learn a single temperature parameter (T>0) which decreases confidence (e.g., if T>1) or increases confidence (e.g., if T<1). As such, temperature scaling allows for the model to come closer to being confidence-calibrated, thereby being closer to accuracy-equals-confidence, resulting in lower expected calibration error(s) (ECE). After temperature scaling, the uncertainty identifier 625 determines an average predictive uncertainty (uᵢ) for accurate and/or inaccurate predictions from an uncalibrated model (block 1115). For example, the uncertainty threshold for calculating n_{AC}, n_{AU}, n_{IC}, and n_{IU} can be obtained by determining the average predictive uncertainty for accurate and inaccurate predictions from the uncalibrated model on the hold-out validation data D_{V}, as described in connection with Equation 15 (block 1120). As such, the post-hoc calibrator 685 can calculate the values for n_{AC}, n_{AU}, n_{IC}, and n_{IU} based on the determined uncertainty threshold (block 1125).

FIG. 12 includes example programming code 1200 representative of machine readable instructions of FIGS. 7-8 that may be executed to implement the example uncertainty calibrator 520 of FIG. 6 to perform accuracy versus uncertainty calibration (AvUC) optimization for a stochastic neural network. The programming code 1200 can be implemented in any type of development environment (e.g., MATLAB, etc.). In the example of FIG. 12, the example instructions at reference number 1205 implement Equations 1-2 to introduce a dataset D, while also establishing variational parameters (θ), setting weight priors, initializing variational parameters, and/or defining a learning schedule. For example, a pre-defined learning schedule can be used to reduce a learning rate as the training progresses. In some examples, the learning rate schedule can include a time-based decay, a step decay, and/or an exponential decay. The example instructions at reference number 1210 implement Equation 3 to define a mini-batch (B) of samples. For example, during training a group of randomly sampled examples (e.g., mini-batches) can be processed per iteration, wherein each batch contains B=N/M examples. To perform stochastic forward passes as described in connection with FIG. 8, T Monte Carlo samples are applied to determine a predictive distribution (e.g., pᵢ(y|xᵢ, w) as based on Equation 4). As shown by example instructions at reference number 1215, a predictive distribution is determined based on the stochastic forward passes, including a predicted label, a probability of predicted class, and/or a predictive uncertainty (e.g., using equations defined in connection with FIG. 3). As such, the number of accurate and certain predictions (n_{AC}), the number of accurate and uncertain predictions (n_{AU}), the number of inaccurate and certain predictions (n_{IC}), and/or the number of inaccurate and uncertain predictions (n_{IU}) is determined based on the example instructions at reference number 1220. Additionally, the total loss is calculated based on Equation 14, such that the loss function of Equation 9 is combined with the negative ELBO loss function and/or the Kullback-Leibler (KL) divergence, as described in more detail below.

In the example of FIG. 12, SVI-AvUC optimization is performed during training of a Bayesian deep neural network. Bayesian deep neural networks provide a probabilistic interpretation of deep learning models by learning probability distributions over the neural network weights (w). For example, in a Bayesian setting, a distribution can be inferred over weights w. A prior distribution can be assumed over the weights p(w) that captures which parameters are likely to generate the outputs before observing any data. Given evidence data p(y|x), prior distribution p(w) and model likelihood p(y|x,w), the posterior distribution can be inferred over the weights p(w|D), in accordance with Equation 16:

$$p ( w \text{\textbar} D ) = \frac{p ( y \text{\textbar} x , w ) p ( w )}{\int p ( y \text{\textbar} x , w ) p ( w ) dw} \qquad Equation 16$$

SVI can be used to approximate a complex probability distribution p(w|D) with a simpler distribution q₀(w), parameterized by variational parameters θ while minimizing the Kullback-Leibler (KL) divergence. Minimizing the KL divergence is equivalent to maximizing the log evidence lower bound (ELBO), as shown in Equation 17. Conventionally, the ELBO los (negative ELBO) (e.g., as shown in Equation 18), can be minimized while training deep neural networks with stochastic gradient descent optimization:

[symbol]

:= [symbol] _{q}_{_{θ}}_{(w)} [log p(y|x,w)]−KL[q_{θ}(w)∥p(w)] Equation 17

[symbol]

_{ELBO}:=− [symbol] _{q}_{_{θ}}_{(w)} [log p(y|x,w)]+KL[q_{θ}(w)∥p(w)] Equation 18

In mean-field stochastic variation inference, weights are modeled with fully factorized Gaussian distribution parameterized by variational parameters μ and σ, such that q_{θ}(w)= [symbol] (w|μ, σ). For example, the variational distribution q_{θ}(w) and its parameters μ and σ are learned while optimizing the cost function ELBO with the stochastic gradient steps.

In the examples disclosed herein, predictive distribution is obtained through multiple stochastic forward passes on the network while sampling from the weight posteriors using Monte Carlo estimators. For example, the predictive distribution of the output y given input x can be determined based on Equation 19:

$$p ( y \text{\textbar} x , D ) \approx \frac{1}{T} {\sum }_{t = 1}^{T} p ( y \text{\textbar} x , {w}_{t} ) , {w}_{t} \sim p ( w \text{\textbar} D ) \qquad Equation 19$$

As previously described, two types of uncertainties can constitute predictive uncertainty of models (e.g., aleatoric uncertainty and epistemic uncertainty). While aleatoric uncertainty captures noise inherent with the observation, epistemic uncertainty captures the lack of knowledge in representing model parameters. While probabilistic DNNs can quantify both aleatoric and epistemic uncertainties, deterministic DNNs can capture aleatoric uncertainty. In the examples disclosed herein, predictive entropy is used as the uncertainty metric, which represents predictive uncertainty of the model and captures a combination of both epistemic and/or aleatoric uncertainties in probabilistic models. As disclosed in the examples presented herein, mean-field stochastic variational inference (SVI) in Bayesian neural networks is used, with the entropy of the predictive distribution capturing a combination of aleatoric and epistemic uncertainties, in accordance with Equation 20:

$$ℍ ( y \text{\textbar} x , D ) := - {\sum }_{k} ( \frac{1}{T} {{\sum }^{T}}_{t = 1} p ( y = k \text{\textbar} x , {w}_{t} ) ) log ( \frac{1}{T} {\sum }_{t = 1}^{T} p ( y = k \text{\textbar} x , {w}_{t} ) ) \qquad Equation 20$$

In some examples, the predictive entropy for deterministic models (e.g., vanilla, temp scaling, etc.) can be computed in accordance with Equation 21:

[symbol]

(y|x,D):=−Σₖ(p(y=k|x,w))log(p(y=k|x,w)) Equation 21

Meanwhile, mutual information between weight posterior and predictive distribution captures the epistemic uncertainty, as shown using Equation 22:

MI(y,w|x,D):= [symbol] (y|x,D)− [symbol] _{p(w|D)}[ [symbol] (y|x,w)] Equation 22

Once the example algorithm 1200 of FIG. 12 has determined the predictive uncertainty, the total loss function is calculated, together with gradients of the loss function (e.g., with respect to μ, ρ, etc.). The algorithm 1200 concludes when the calculations are complete and/or when μ and/or ρ have converged.

FIG. 13 includes example programming code 1300 representative of machine readable instructions of FIGS. 7 and 9 that may be executed to implement the example uncertainty calibrator 520 of FIG. 6 to perform accuracy versus uncertainty calibration (AvUC) optimization for a deterministic neural network. The programming code 1300 can be implemented in any type of development environment (e.g., MATLAB, etc.). In the example of FIG. 13, the example instructions at reference number 1305 implement Equations 1-2 to introduce a dataset D, initialize the weights w of the neural network, and/or define a learning rate schedule. The example instructions at reference number 1305 implement Equation 3 to define a mini-batch (B) of samples. For example, during training a group of randomly sampled examples (e.g., mini-batches) are processed per iteration, wherein each batch contains B=N/M examples. Given that a deterministic network is being trained, forward passes can be performed as shown in the programming code at reference number 1310. Similarly, as described in connection with FIG. 12, a predicted class label and/or probability of predicted class can be determined. However, the predictive uncertainty (e.g., predictive entropy) can be calculated based on entropy of softmax, as described in connection with FIG. 9. Example instructions at reference number 1315 calculate the number of accurate and certain predictions (n_{AC}), the number of accurate and uncertain predictions (n_{AU}), the number of inaccurate and certain predictions (n_{IC}), and/or the number of inaccurate and uncertain predictions (n_{IU}). The total loss function is calculated based on Equation 14, with gradients of the loss function determined and weights w updated, such that the algorithm concludes when w has converged and/or the upon completion of the AvUC optimization.

FIGS. 14A-14E include example model calibration comparisons 1400, 1420, 1430, 1440, 1450 of the methods disclosed herein with various high-performing non-Bayesian and Bayesian methods across multiple combinations of data shift, including data shift at different levels of example shift intensities 1410 (e.g., intensity 1-5), based on ResNet-50 deep neural network architectures on CIFAR10 datasets. Data-shift is common in real-world applications (e.g., robotics, autonomous driving, medical diagnosis, etc.) as such environments are dynamic and sensors degrade over a period time. AI models can observe data that shifts from the training data distribution. Obtaining well-calibrated uncertainty helps to trust the model's predictions, as it is essential to avoid inaccurate results. Disclosed herein are results on experiments under data-shift (e.g., 16 different image perturbations and/or corruptions at 5 different intensity levels for each data-shift type, resulting in 80 variations of test data for data-shift evaluation). For example, an empirical evaluation can be performed of the methods disclosed herein by comparing the developed SVI-AvUC and/or SVI-AvUTS method(s) with various non-Bayesian and Bayesian methods, including vanilla deep neural network (Vanilla), Temperature scaling (Temp Scaling), Deep-ensembles (Ensembles), Monte Carlo dropout (Dropout), Mean-field stochastic variational inference baseline (SVI), Radial Bayesian neural networks (Radial BNN), and/or Dropout and SVI on the last layer of neural network (LL-Dropout and LL-SVI). In the examples disclosed herein, scalability of the SVI-AvUC method can be shown to a large-scale ImageNet dataset with ResNet-50 topology and/or ResNet-20 DNN architectures on ImageNet and/or CIFAR10 datasets. Furthermore, model calibration, model performance with respect to confidence and uncertainty estimates, and/or distributional shift detection performance can be evaluated. In the example results disclosed herein, methods are compared under in-distribution and distributional shift conditions with same evaluation criteria. For SVI-AvUC implementation, the same hyperparameters can be used as the SVI baseline.

In some examples, SVI is used as a baseline to illustrate the performance of methods disclosed herein (e.g., AvUC and/or AvUTS). In some examples, SVI is scaled to large-scale ImageNet datasets and ResNet-50 architectures by specifying the weight priors and initializing the variational parameters (e.g., using an Empirical Bayes method, etc.). For example, weights can be modeled with fully factorized Gaussian distributions represented by μ and/or σ. In order to ensure non-negative variance, σ can be expressed in terms of a softplus function with unconstrained parameter ρ (e.g., α=log(1+exp(ρ)). In some examples, the weight prior can be set to [symbol] (w_{MLE}, I) and the variational parameters μ and/or ρ can be initialized with w_{MLE} and log(e^{δ|wMLE|}−1), respectively, where MLE represents an initial maximum likelihood estimate. In some examples, the MLE for weights w_{MLE} can be obtained from pre-trained ResNet-50 models available and δ can be set to 0.5. For example, the SVI model of FIGS. 14A-14E can be trained for fifty epochs (e.g., using an SGD optimizer) with an initial learning rate of 0.001, a momentum of 0.9, a weight decay of 1e⁻⁴, and/or a batch size of ninety-six. In some examples, a learning rate schedule can be used that multiplies the learning rate by 0.1 every thirty epochs. The training samples can also be distorted (e.g., with random horizontal flips and/or random crops), and a total of one hundred twenty-eight Monte Carlo samples can be used from the weight posterior for evaluation.

While the SVI model is trained as described above, the SVI-AvUC model is trained with the same hyper-parameters and initialization with Empirical Bayes, except that this SVI-AvUC model is trained with AvUC loss with respect to ELBO loss (e.g., for ImageNet/ResNet-50). For CIFAR10/ResNet-20, the SVI-AvUC model is trained with the same hyperparameters used for SVI on CIFAR10 for a fair comparison. In some examples, the model(s) can be trained with an Adam optimizer for two hundred epochs with an initial learning rate of 1.189e⁻³ and a batch size of one hundred and seven. In some examples, the initial learning rate scheduled can be multiplied by 0.1, 0.01, 0.001, and/or 0.0005 at epochs eighty, one hundred twenty, one hundred sixty, and/or one hundred eighty, respectively. Likewise, the training samples can be distorted (e.g., with random horizontal flips and/or random crops with 4-pixel padding). In some examples, the hyperparameter can be set at 0=3 for relative weighting of AvUC loss with respect to ELBO loss. Similarly, a total of twenty-eight Monte Carlo samples can be used from the weight posterior for evaluation.

With respect to the SVI-AvUTS model for ImageNet/ResNet-50, an optimal temperature for a pre-trained SVI model can be found by minimizing the accuracy versus uncertainty calibration (AvUC) loss on hold-out validation data. In some examples, a total of 50,000 images can be used for finding the optimal temperature to modify the logits of pretrained SVI. Similarly, a total of 128 Monte Carlo samples can be used from the weight posterior for evaluation. Meanwhile, the CIFAR10 training data can be split into a 9:1 ratio (e.g., 45,000 training set and a 5,000 hold-out validation set of images).

The AvUTS model for ImageNet/Res-Net 50 can be tested by applying the AvU temperature scaling method on a pre-trained vanilla ResNet-50 model with AvUC loss to allow for a comparison with conventional temperature scaling that optimizes negative log-likelihood loss. An entropy of softmax can be used as uncertainty for an AvUC loss computation. In the example of the AvUTS model for ImageNet/Res-Net 50, the same methodology can be followed as described in connection with the SVI-AvUTS model above, except for the methodology being applied to a deterministic model.

When comparing the SVI-AvUC and/or SVI-AvUTS methods with Radial BNN, ResNet-20 for Radial BNN can be implemented. In some examples, the models can be trained with an Adam optimizer for 200 epochs with an initial learning rate of 1e⁻³ and a batch size of 256. In some examples, the initial learning rate schedule can be multiplied by 0.1, 0.01, 0.001, and/or 0.0005 at epochs 80, 120, 160, and/or 180, respectively. Likewise, the training samples can be distorted with random horizontal flips and/or random crops with 4-pixel padding. In some examples, a total of 10,000 test images can be evaluated, along with 80 variants of dataset shift (e.g., each with 10,000 images) that can include 16 different types of data-shift at five different intensities. In some examples, out-of-distribution (OOD) evaluation can be performed using an SVHN dataset as OOD data on models trained with CIFAR10.

In the example of FIGS. 14A-14E, a model calibration using the example models 1415 for comparison is shown using example expected calibration error 1405 (ECE↓) 1405 and example expected uncertainty calibration error 1425 (UCE↓). Likewise, example negative log-likelihood 1435 (NLL↓) and/or example Brier score 1445 metrics (Brier score↓) obtained from different methods on ImageNet (ResNet-50). In some examples, the comparison is across 80 combinations of data shift, including 16 different types of shift and/or 5 different levels of shift intensities. As previously explained, a well-calibrated model should consistently provide lower ECE, UCE, NLL, and/or Brier score even at increased levels of data shift, as accuracy can degrade with increased data shift. For example, at each shift intensity level 1410, the boxplots of model calibration comparisons 1400, 1420, 1430, 1440, 1450 summarize results across 16 different data-shift types, showing the minimum, maximum, mean, and/or quartiles associated with each data set. As data shift intensity increases, the SVI-AvUTS and AVI-AvUC models show consistently lower values for ECE, UCE, NLL, and/or Brier score when compared to the other example models 1415 (e.g., FIGS. 14A-14D), while overall example accuracy 1455 remains high (e.g., FIG. 14E). Additional model calibration evaluation metrics are described below to provide more detail as to how the metrics are determined.

Expected calibration error (ECE) measures the difference in expectation between model accuracy and its confidence, as defined in connection with Equation 23:

$$ECE = {\sum }_{l = 1}^{L} \frac{\vert {B}_{l} \vert}{N} \vert acc ( {B}_{l} ) - conf ( {B}_{l} ) \vert \qquad Equation 23$$

ECE quantifies the model miscalibration with respect to confidence (probability of predicted class). For example, the predictions of the neural network are partitioned into L bins of equal width, where l^{th} bin is the interval

$$( \frac{l - 1}{L} , \frac{l}{L} ] .$$

In the example of Equation 23, N represents a total number of samples and Bₗ represents the set of indices of samples whose prediction confidence falls into the l^{th} bin. The model accuracy and confidence per bin can be defined in accordance with Equation 24:

$$acc ( {B}_{l} ) = \frac{1}{\vert {B}_{l} \vert} {\sum }_{i ∈ {B}_{l}} 𝕀 ( {\hat{y}}_{i} = {y}_{i} ) ; conf ( {B}_{l} ) = \frac{1}{\vert {B}_{l} \vert} {\sum }_{i ∈ {B}_{l}} {p}_{i} \qquad Equation 24$$

Expected uncertainty calibration error (UCE) measures the difference in expectation between model error and its uncertainty as defined in Equation 25:

$$UCE = {\sum }_{l = 1}^{L} \frac{\vert {B}_{l} \vert}{N} \vert err ( {B}_{l} ) - uncert ( {B}_{l} ) \vert \qquad Equation 25$$

In the example of UCE, the model error and uncertainty per bin can be defined as shown in Equation 26, where ũᵢ∈[0,1] represents normalized uncertainty:

$$err ( {B}_{l} ) = \frac{1}{\vert {B}_{l} \vert} {\sum }_{i ∈ {B}_{l}} 𝕀 ( {\hat{y}}_{i} \neq {y}_{i} ) ; uncert ( {B}_{l} ) = \frac{1}{\vert {B}_{l} \vert} {\sum }_{i ∈ {B}_{l}} {\tilde{u}}_{i} \qquad Equation 26$$

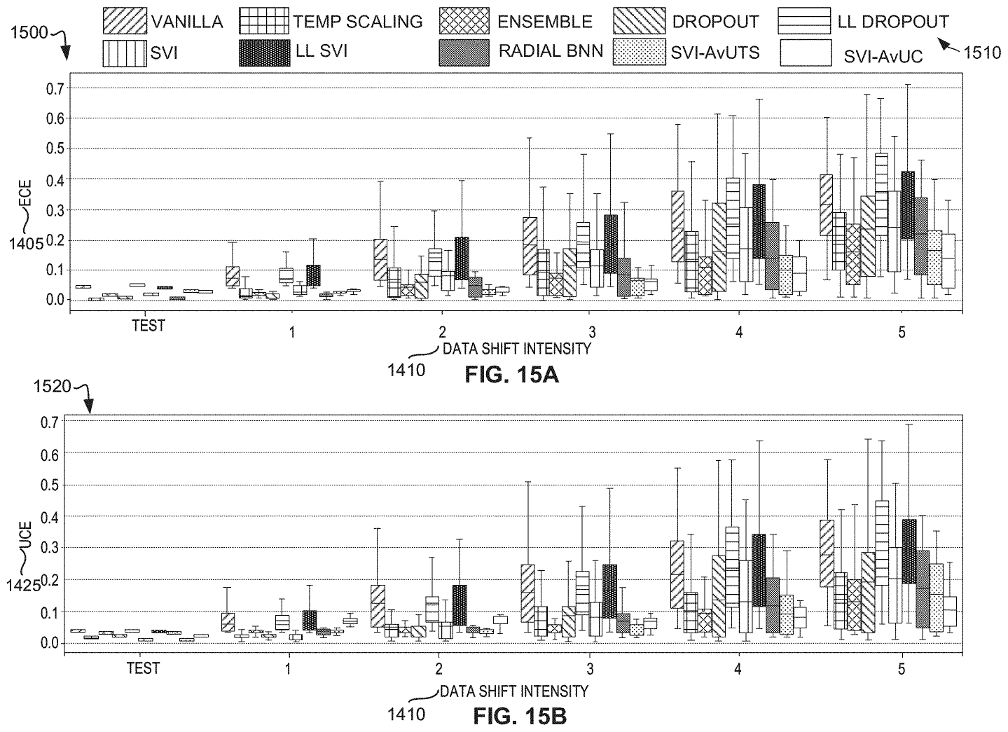

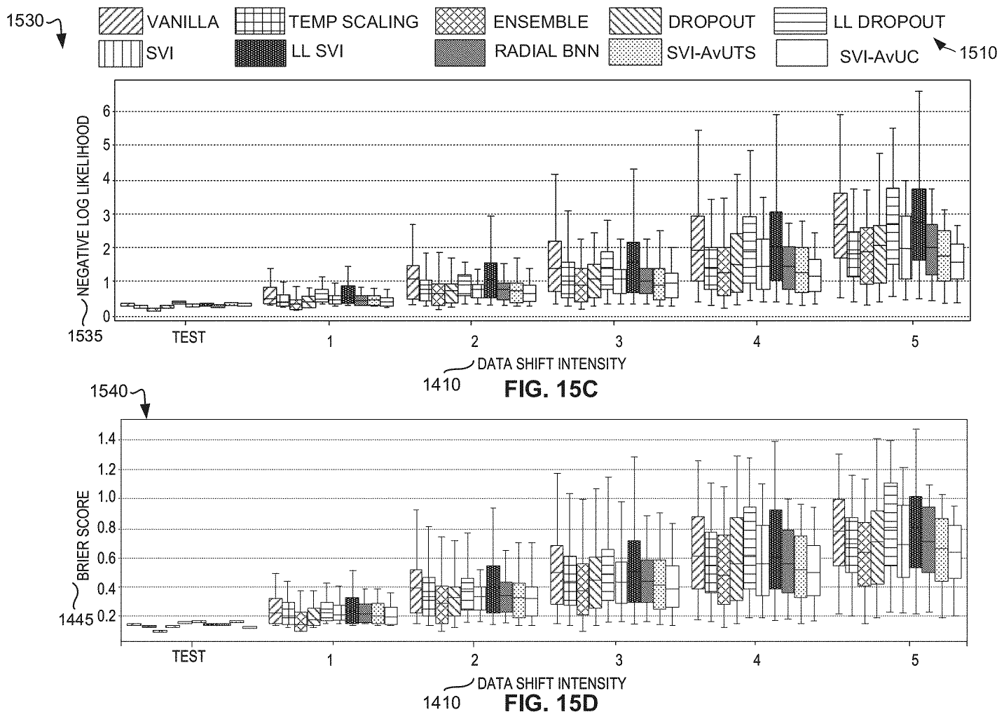

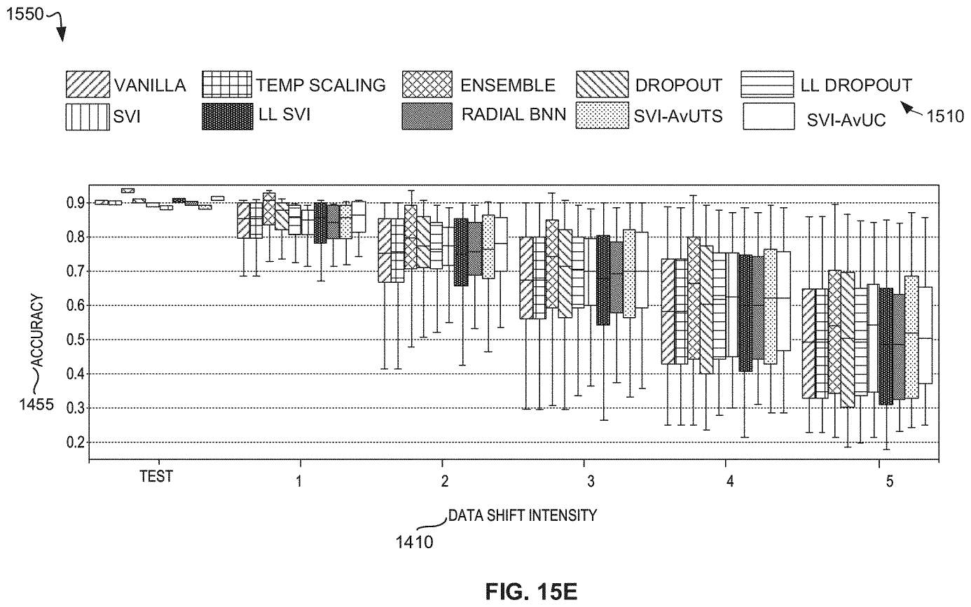

FIGS. 15A-15E include example model calibration comparisons 1500, 1520, 1530, 1550 of the methods disclosed herein with various high-performing non-Bayesian and Bayesian methods across multiple combinations of data shift, including data shift at different levels of shift intensities 1410 (e.g., intensities 1-5), based on ResNet-20 deep neural network architectures on CIFAR10 datasets. As described in connection with FIGS. 14A-14E, model calibration comparisons are performed using ECE 1405, UCE 1425, NLL 1435, Brier score 1445, with additional evaluation of accuracy 1455. The example models 1510 include Radial Bayesian neural networks (Radial BNN). As expected, a well-calibrated model should consistently provide lower ECE, UCE, NLL, and/or Brier score even at increased levels of data-shift. The boxplots of calibration comparisons 1500, 1520, 1530, 1550 summarize the results across 16 different data-shift types showing the minimum, maximum, mean, and quartiles. As data shift intensity increases, the SVI-AvUTS and AVI-AvUC models show consistently lower values for ECE, UCE, NLL, and/or Brier score when compared to the other example models 1510 (e.g., FIGS. 15A-15D), while overall example accuracy 1455 remains high (e.g., FIG. 15E).

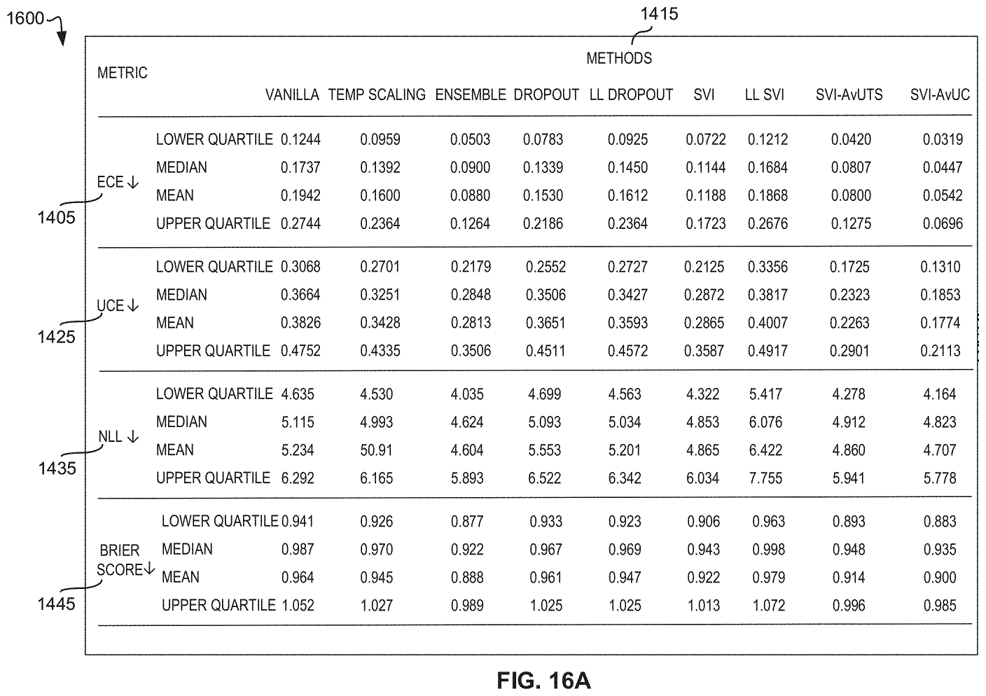

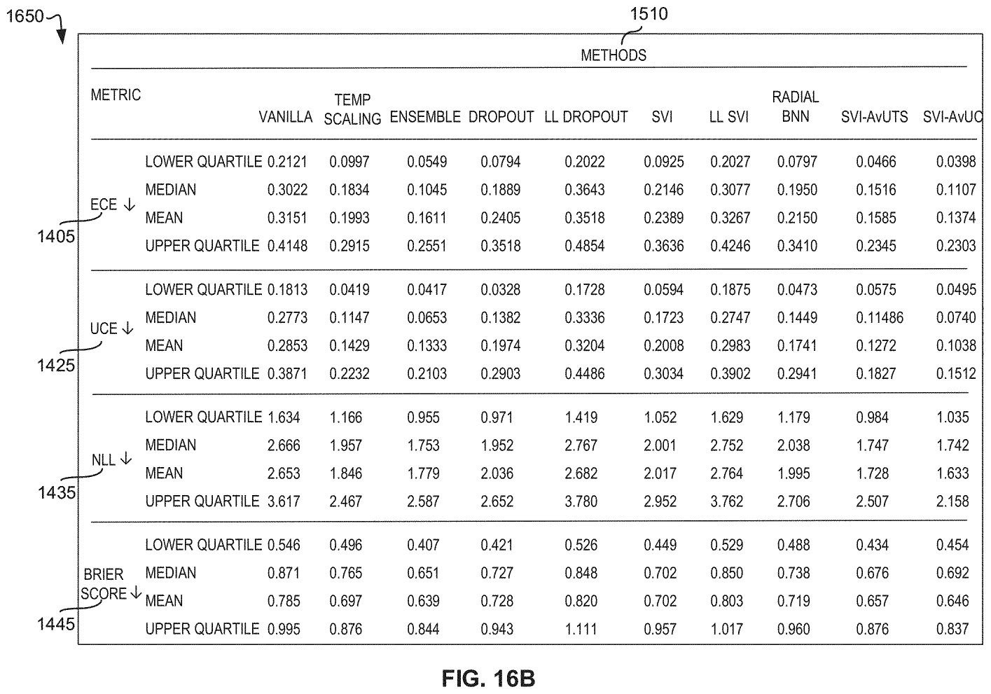

FIGS. 16A-16B include calibration results 1600, 1650 under distributional shift using ImageNet and CIFAR 10 datasets. In the example of calibration results 1600, the lower quartile (e.g., 25^{th} percentile), median (e.g., 50^{th} percentile), mean and upper quartile (e.g., 75^{th} percentile) is shown for each of the ECE 1405, UCE 1425, NLL 1435, Brier score 1445, which are computed across the 16 different types of data-shift at multiple intensities (e.g., corresponding to ImageNet-associated data of FIGS. 14A-14D). As such, the results of FIGS. 14A-14D are presented in tabulated form in FIG. 16A, while the results of FIGS. 15A-15D are presented in tabulated form in FIG. 16B (e.g., corresponding to CIFAR10-associated data).

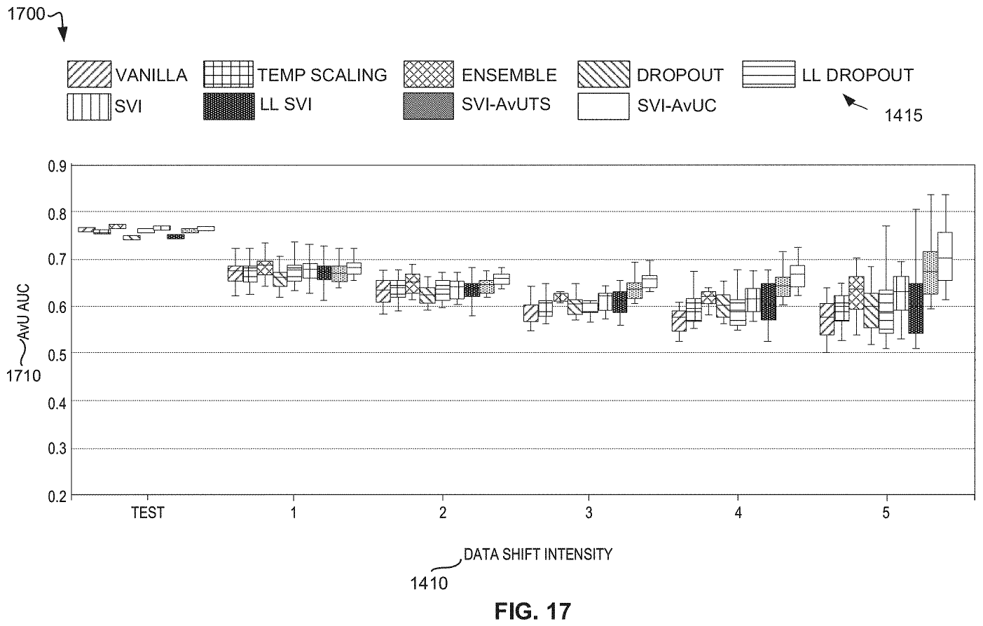

FIG. 17 illustrates a comparison 1700 between accuracy versus uncertainty measures on in-distribution and under dataset shift at different levels of shift intensities 1410, based on the models 1415. A well-calibrated model is expected to provide a consistently higher AvU AUC score even at increased levels of data-shift. In the example of FIG. 17, boxplots summarize results across 16 different data-shift types (e.g., including showing minimum, maximum, and quartiles) at each shift intensity level (1.g., 1-5). The data indicates the SVI-AvUC and SVI-AvUTS models provide higher area under the curve (AUC) of AvU (AvU AUC) computed across various uncertainty thresholds. In some examples, the AUC can be optimized across various uncertainty thresholds towards a threshold free mechanism. Such a method can be compute intensive during training as AvU is computed at different thresholds (e.g., uₜₕ=uₘᵢₙ+(t (uₘₐₓ−uₘᵢₙ)), where t∈[0,1]. In some examples, optimizing the area under the curve can be performed for training the model and/or post-hoc calibration on SVI (e.g., SVI-AUAvUC and/or SVI-AUAvUTS).

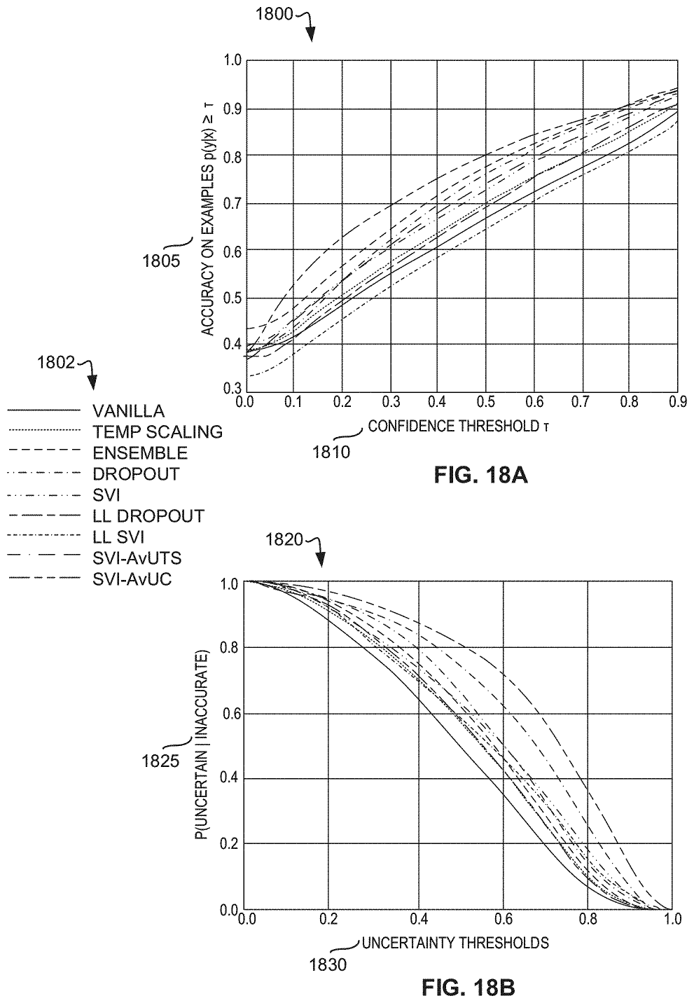

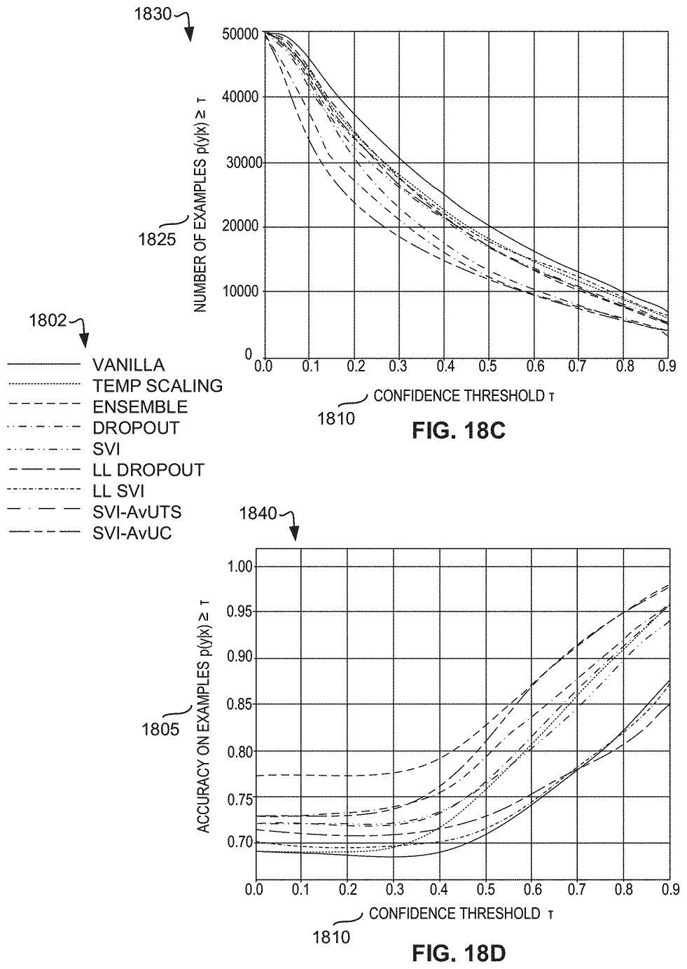

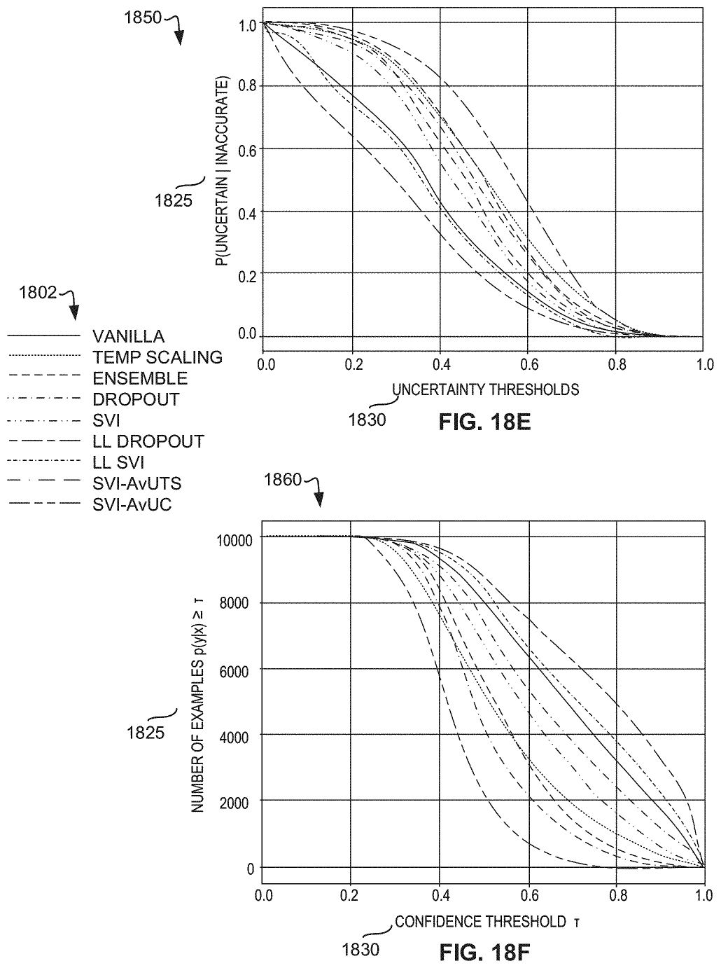

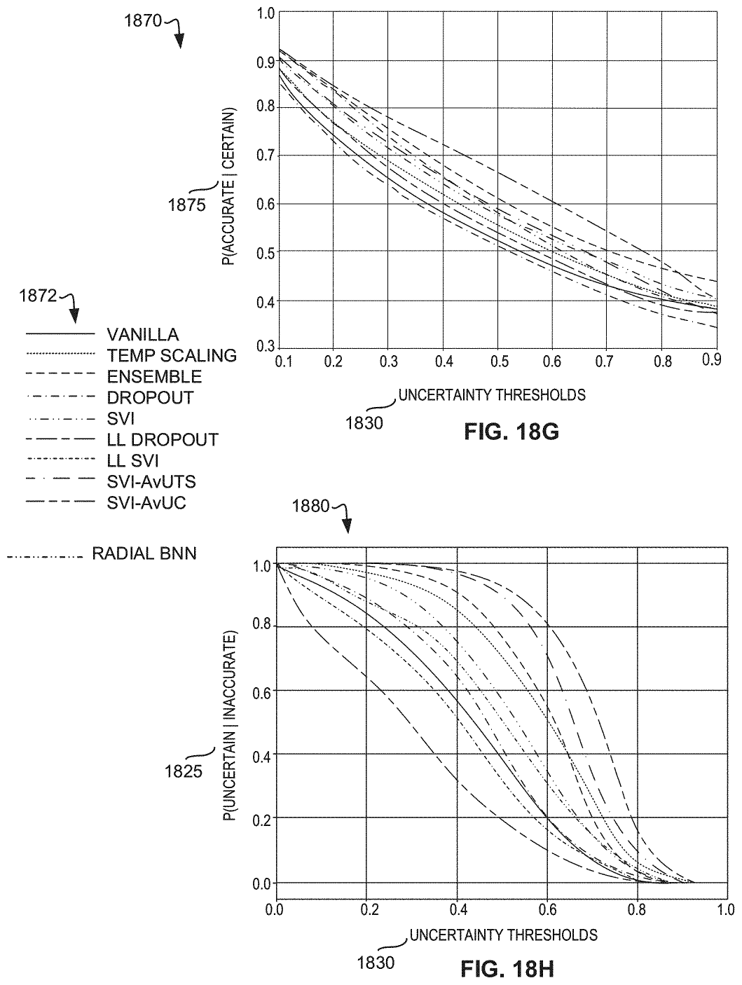

FIGS. 18A-18I illustrate model confidence and uncertainty evaluation 1800, 1820, 1830, 1840, 1850, 1860, 1870, 1880, 1890 under distributional shift, including accuracy as a function of confidence, probability of the model being uncertain when making inaccurate predictions, and a density histogram of entropy on out-of-distribution (00D) data. In FIGS. 18A-18I, quality of confidence measures is evaluated using accuracy versus confidence plots, while quality of predictive uncertainty estimates is evaluated using p(accurate certain) and p(uncertain|inaccurate) metrics across various uncertainty thresholds. As previously described, a reliable model should be accurate when it is certain about its predictions and indicate high uncertainty when it is likely to be inaccurate. For example, conditions probabilities p(accurate|certain) and p(uncertain|inaccurate) can be used as model performance evaluation metrics for comparing the quality of uncertainty estimates obtained from different probabilistic methods. For example, p(accurate|certain) can be defined in accordance with Equation 27, while p(uncertain|inaccurate) can be defined in accordance with Equation 28:

$$\begin{matrix}p ( accurate \text{\textbar} certain ) = \frac{{n}_{A C}}{{n}_{A C} + {n}_{IC}} & Equation 27 \\ p ( uncertain \text{\textbar} inaccurate ) = \frac{{n}_{IU}}{{n}_{IC} + {n}_{IU}} & Equation 28\end{matrix}$$

As shown in Equation 27, p(accurate|certain) measures the probability that the model is accurate in its output given that it is confident on the same, while Equation 28 shows that p(uncertain|inaccurate) measures the probability that the model is uncertain about its output given that it has made an inaccurate prediction.

In the example of FIGS. 18A-18I, model confidence and uncertainty are evaluated under distributional shift (e.g., dataset shift on ImageNet and CIFAR10 with Gaussian blur of intensity 3). In the examples of FIGS. 18A-18I, the results are based on a comparison of models 1802, 1872. FIGS. 18A and 18D show example accuracy 1805 as a function of example confidence 1810. In FIGS. 18A and 18D, SVI-AvUC shows higher accuracy at higher confidence. FIG. 18G shows example probability 1875 of the model being accurate when certain about its predictions (e.g., based on example uncertainty thresholds 1830). In FIG. 18G, SVI-AvUC is more accurate at lower uncertainty. FIGS. 18B, 18E, 18H show example probability 1825 of the model being uncertain when making inaccurate predictions (e.g., based on example uncertainty thresholds 1830). In FIGS. 18B, 18E, 18H, SVI-AvUC is more uncertain when making inaccurate predictions under distributional shift, compared to other methods. Normalized uncertainty thresholds t∈[0,1] are shown, given that uncertainty range varies for different methods. FIGS. 18C and 18F illustrate the number of examples above a given confidence value. In FIGS. 18C and 18F, SVI-AvUC has a lesser number of examples with higher confidence under distributional shift. FIG. 18I shows an example density 1892 histogram of example predictive entropy 1895 on OOD data. In FIG. 18I, SVI-AvUC provides higher predictive entropy on out-of-distribution data. As such, SVI-AvUC improves the quality of confidence and uncertainty measures over the SVI baseline, while preserving or improving accuracy.

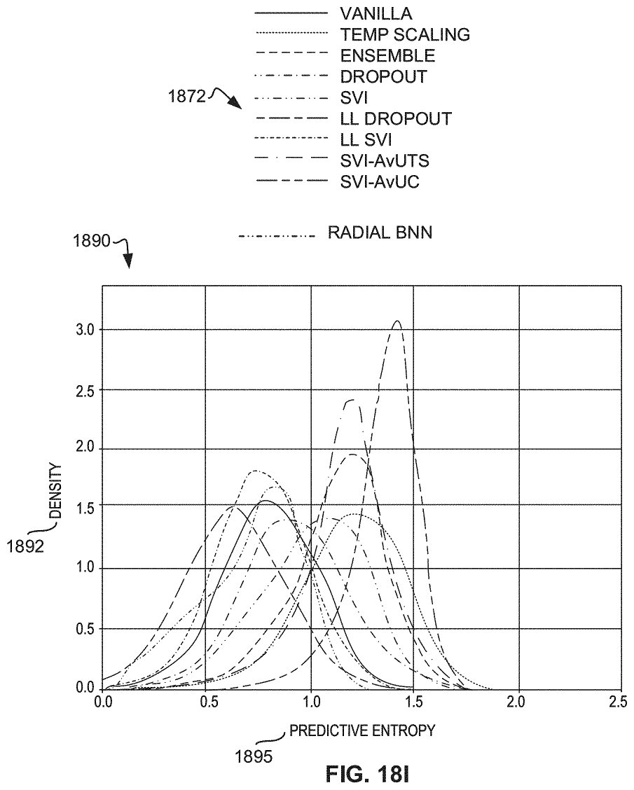

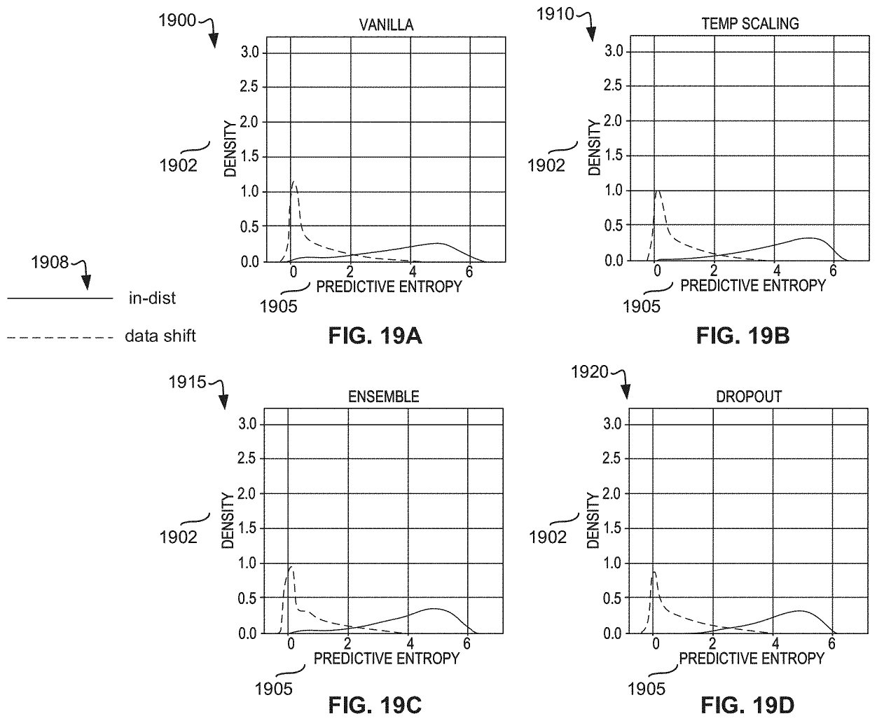

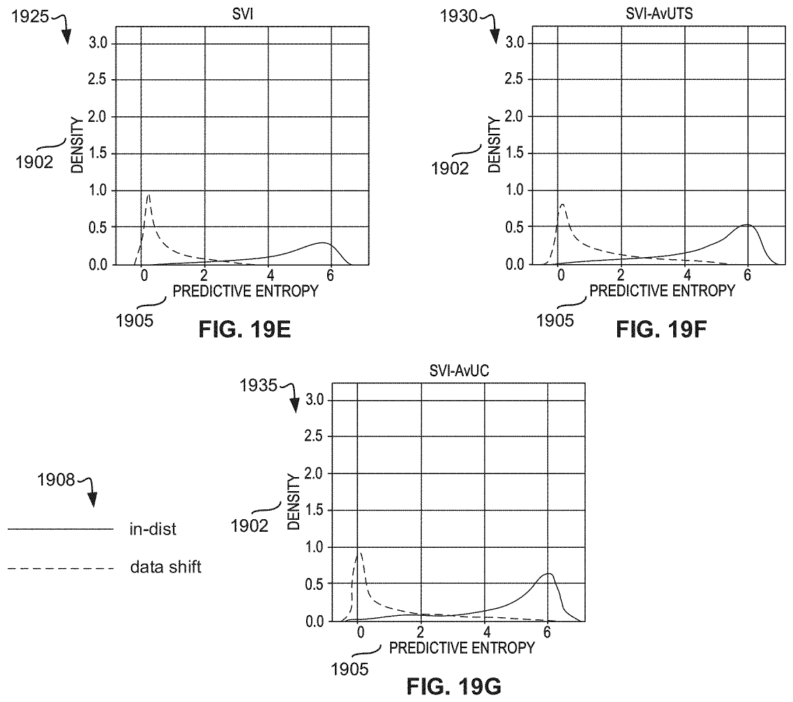

FIGS. 19A-19G illustrate density histograms 1900, 1910, 1915, 1920, 1925, 1930, 1935 of example predictive entropy 1905 on an example data set 1908 including an ImageNet in-distribution test set and data shifted with Gaussian blur of intensity. In the examples of FIGS. 19A-19G, which illustrate the density histograms for the various models being compared with SVI-AvUTS 1930 and/or SVI-AvUC 1935 (e.g., vanilla 1900, temperature scaling 1910, ensemble 1915, dropout 1920, SVI 1925, etc.), the SVI-AvUC data set shows an optimal separation of densities between in-distribution data and data-shift.

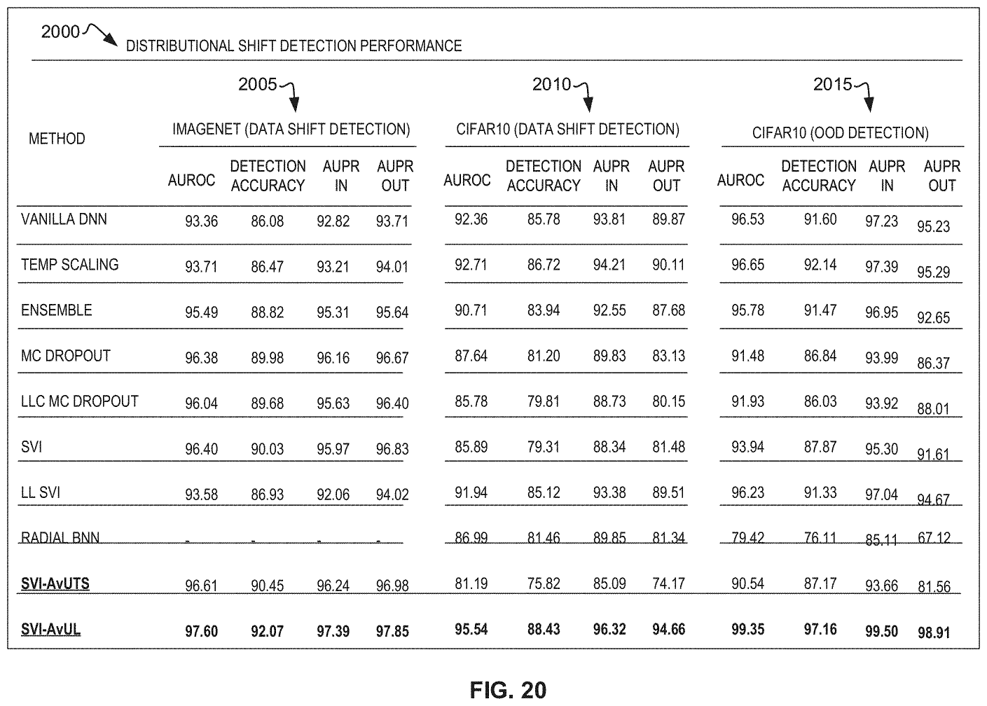

FIG. 20 illustrates distributional shift detection performance 2000 using predictive uncertainty on ImageNet 2005 and CIFAR10 2010, 2015 datasets based on data shifted with Gaussian blur of intensity. In the example of FIG. 20, SVHN can be used as an out-of-distribution (OOD) data for OOD detection of model(s) trained with CIFAR10. In FIG. 20, values are shown as percentages and optimal results are indicated in bold (e.g., for the SVI-AvUC model). As such, the SVI-AvUC model outperforms across all metrics. With respect to FIG. 20, performance of detecting distributional shift in neural networks can be evaluated using uncertainty estimates. For example, this can be a binary classification problem of identifying if an input sample is from in-distribution or shifted data. For example, metrics used for the evaluation(s) performed in FIG. 20 include AUROC, AUPR, and/or detection accuracy. Higher uncertainty under distributional shift is expected as the model tends to make inaccurate predictions and lower uncertainty for in-distribution data. As described in connection with FIGS. 19A-19G, a better separation of entropy densities for SVI-AvUC is shown as compared to other methods. Likewise, results of FIG. 20 show the model SVI-AvUC outperform other methods in distributional shift detection.

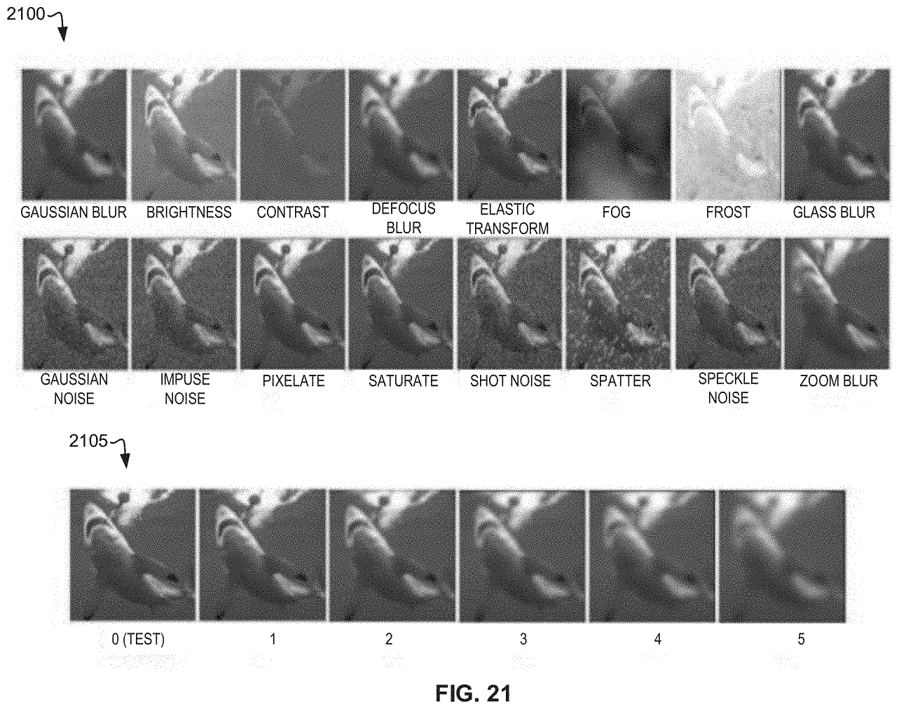

FIG. 21 illustrates example image corruptions and perturbations 2100 used for evaluating model calibration under dataset shift, including different example shift intensities 2105 for Gaussian blur. For example, the image corruptions and perturbations 2100 of FIG. 21 can be used for evaluating model calibration under dataset shift, based on a methodology in uncertainty quantification (UQ) benchmark to evaluate the methods proposed herein with high performing baselines provided in the UQ benchmark. For dataset shift evaluation, 16 different types of image corruptions at 5 different levels of intensities can be utilized, resulting in 80 variants of data-shift. For example, image corruptions and perturbations 2100 of FIG. 21 show an example of 16 different data-shift types (e.g., Gaussian blur, brightness, contrast, defocus blur, etc.) at intensity level 3 on ImageNet, while different shift intensities 2105 (e.g., from level 1 to level 5) are shown for Gaussian blur. Such data-shifts can be applied to CIFAR10 in addition to ImageNet. While the data-shifts of FIG. 21 are encountered during test time, models can be trained using clean data (e.g., without image corruptions and/or perturbations).

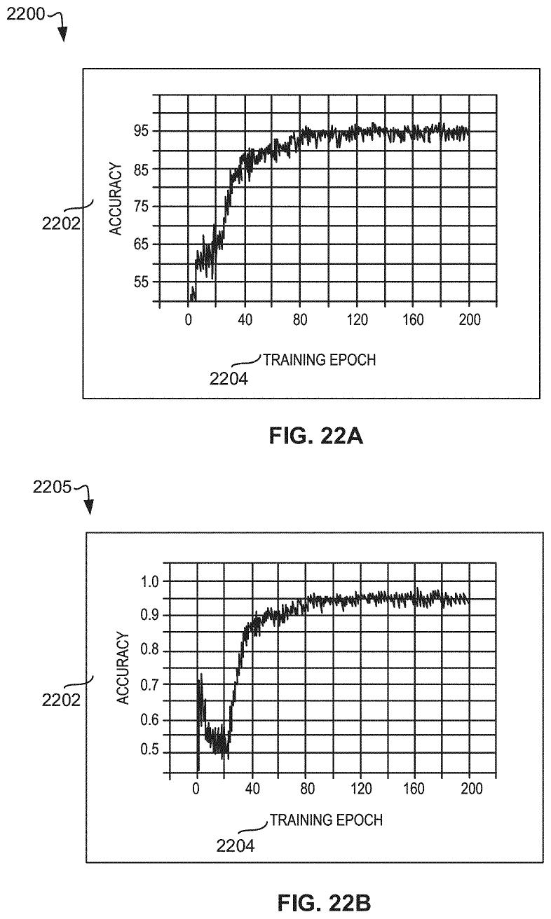

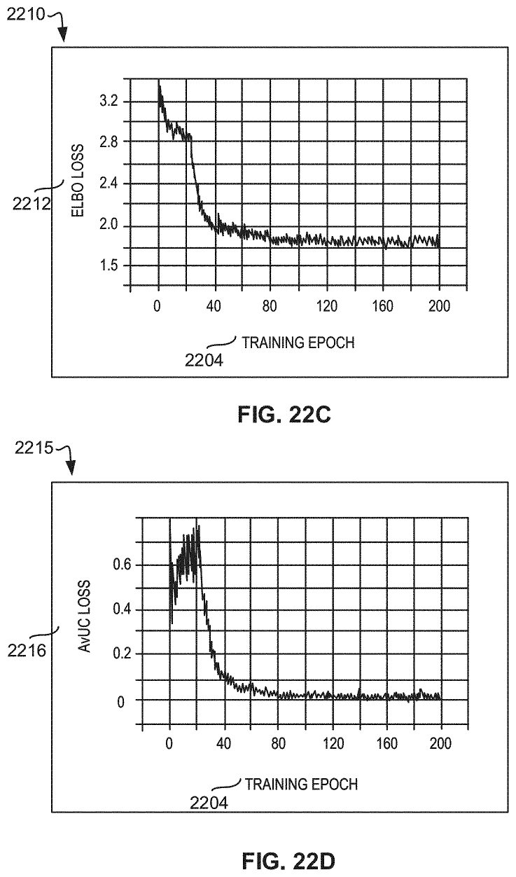

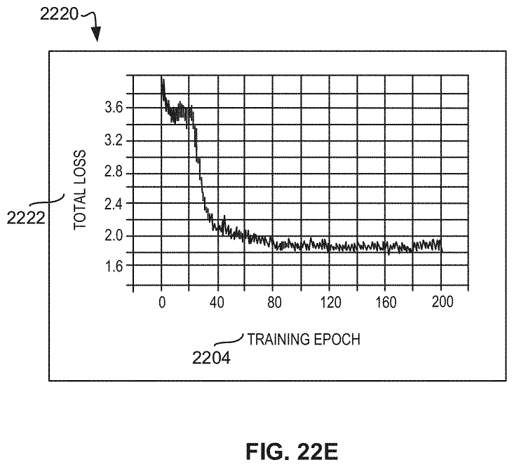

FIGS. 22A-22E illustrate example results 2200, 2205, 2210, 2215, 2220 for monitoring metrics and loss functions while training a mean-field stochastic variational inference (SVI)-based Accuracy versus Uncertainty Calibration (AvUC) model. In the example of FIGS. 22A-22E, example accuracy 2202, example AvU score 2203, example ELBO loss 2212, example AvUC loss 2216, and example total loss 222 can be monitored at each example training epoch 2204. As previously described in connection with Equation 14, ELBO loss includes negative expected log-likelihood and Kullback-Liebler divergence. ELBO loss can be observed to decrease as accuracy is increasing, indicating the inverse correlation between ELBO loss and accuracy. In some examples, ELBO loss can be seen to decrease even if the AvU score is not increasing. In FIGS. 22B and 22D, the proposed differentiable AcUC loss and the actual AvU metric are inversely correlated, guiding the gradient optimization of total loss with respect to improving both accuracy and uncertainty calibration.

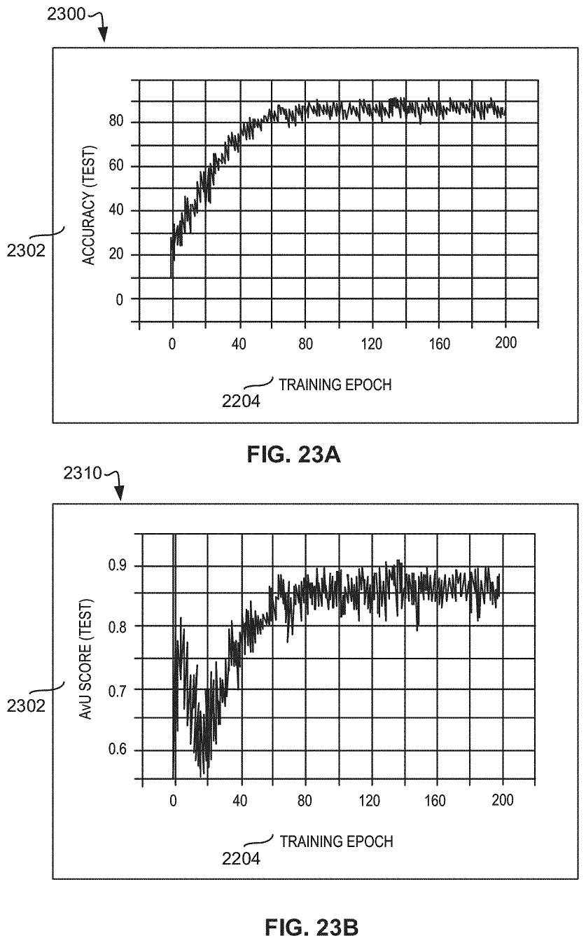

FIGS. 23A-23B illustrate example results 2300, 2310 for monitoring example accuracy 2302 and AvU-based metrics on test data after each example training epoch 2204 using the mean-field stochastic variational inference (SVI)-based Accuracy versus Uncertainty Calibration (AvUC) model. In the example of FIGS. 23A-23B, accuracy and AvU score are obtained on test data from 1 Monte Carlo sample at the end of each training epoch (e.g., for monitoring purposes). However, during the evaluation phase the model accuracy and AvU score are higher given the use of a larger number of Monte Carlo samples to marginalize over the weight posterior.

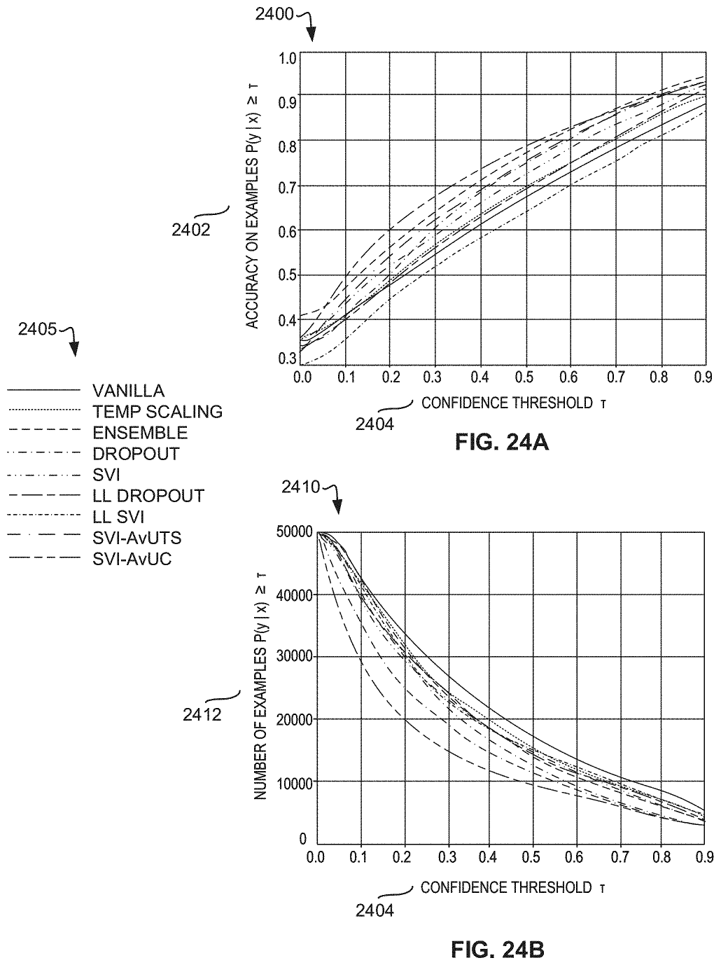

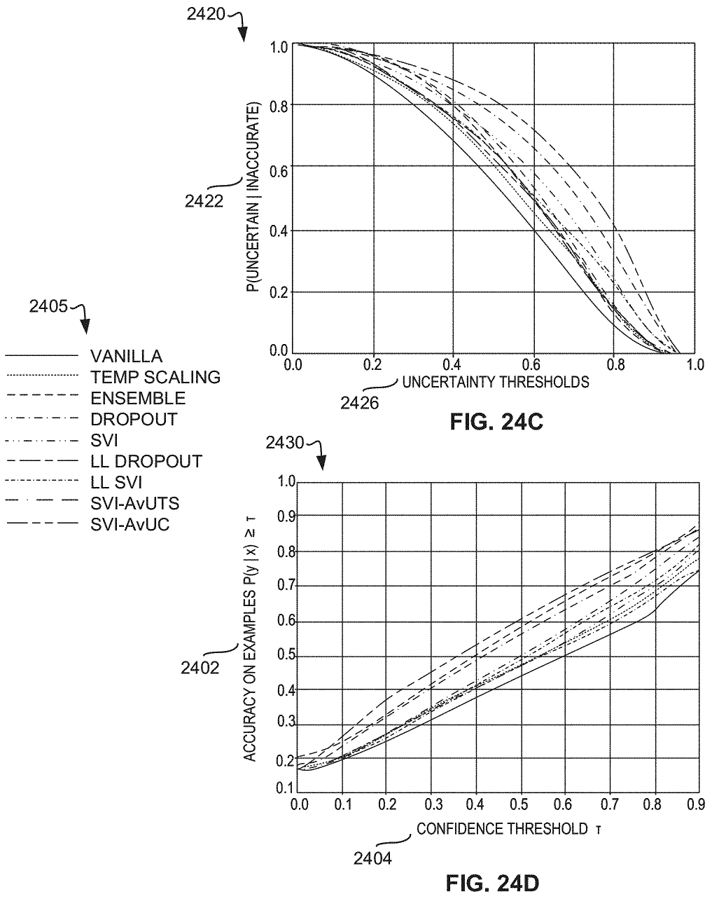

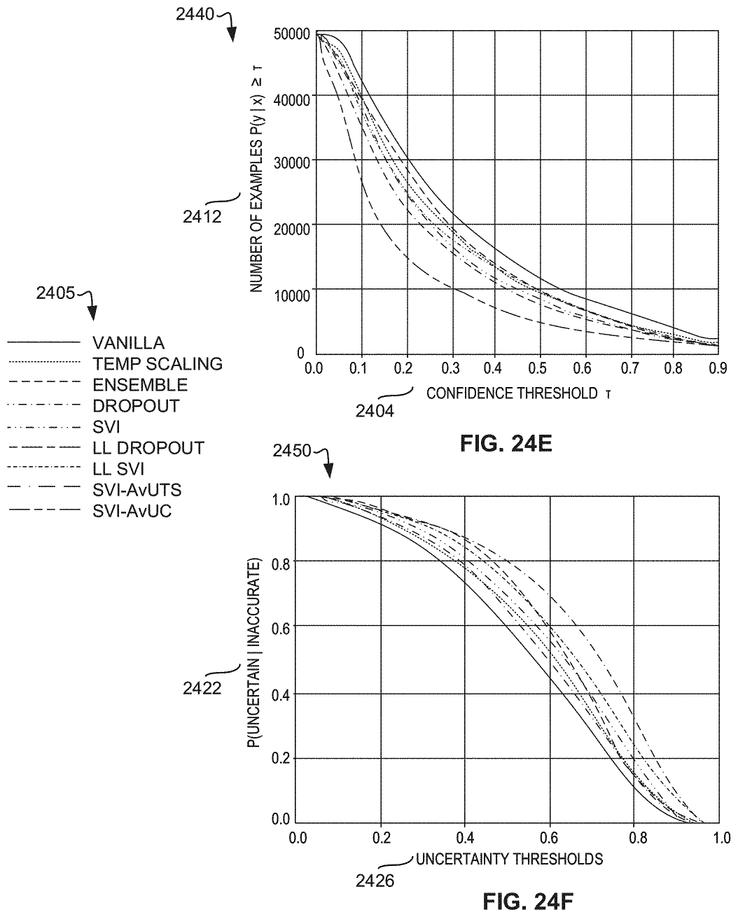

FIGS. 24A-24F illustrate example results 2400, 2410, 2420, 2430, 2440, 2450 for confidence and uncertainty evaluation under distributional shift using the defocus blur and glass blur image corruptions on ImageNet datasets. In the example of FIGS. 24A, 24F, model confidence and uncertainty evaluation under distributional shift is shown (e.g., using defocus blur and glass blur of intensity 3). In FIGS. 24A, 24D, an example accuracy on examples 2402 is shown as a function of confidence, with the expectation that a reliable model is more accurate at higher confidence values. In FIGS. 24B, 24E, an example number of examples 2412 is shown above a given confidence value, with the expectation that a reliable model has a lesser number of examples with higher confidence as accuracy is significantly degraded under distributional shift. In FIGS. 24C, 24F, an example probability 2422 of the model being uncertain when making inaccurate predictions is shown, with the expectation that a reliable model is more uncertain when it is inaccurate. Normalized uncertainty thresholds t E [0,1] are shown, given that uncertainty range varies for different methods. In FIGS. 24A-24F, the SVI-AvUC model outperforms other example methods 2505 that the SVI-AvUC model is compared to.

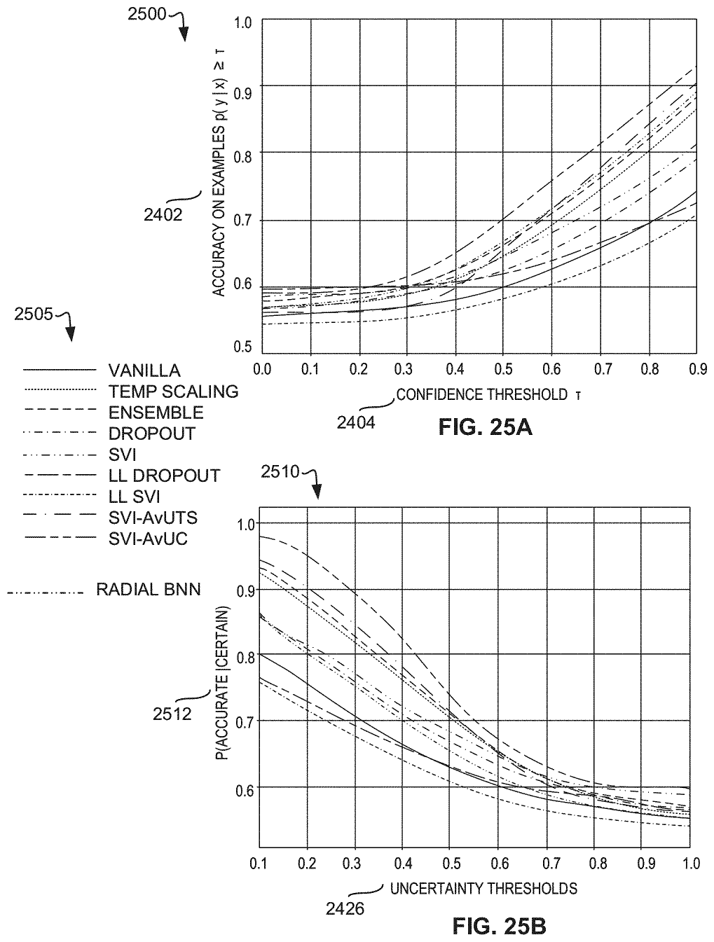

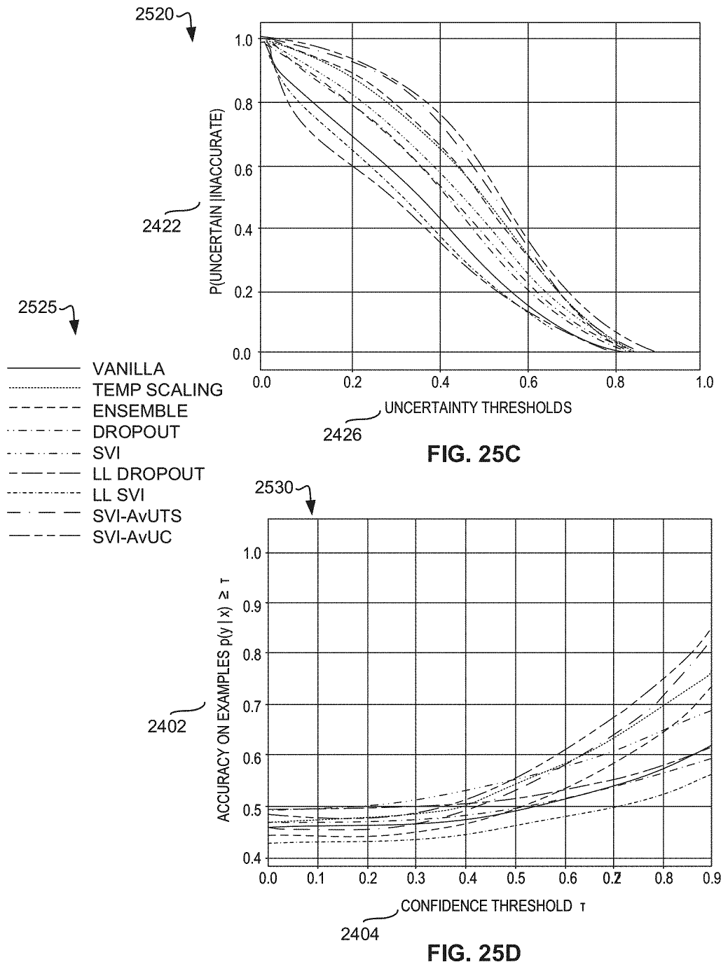

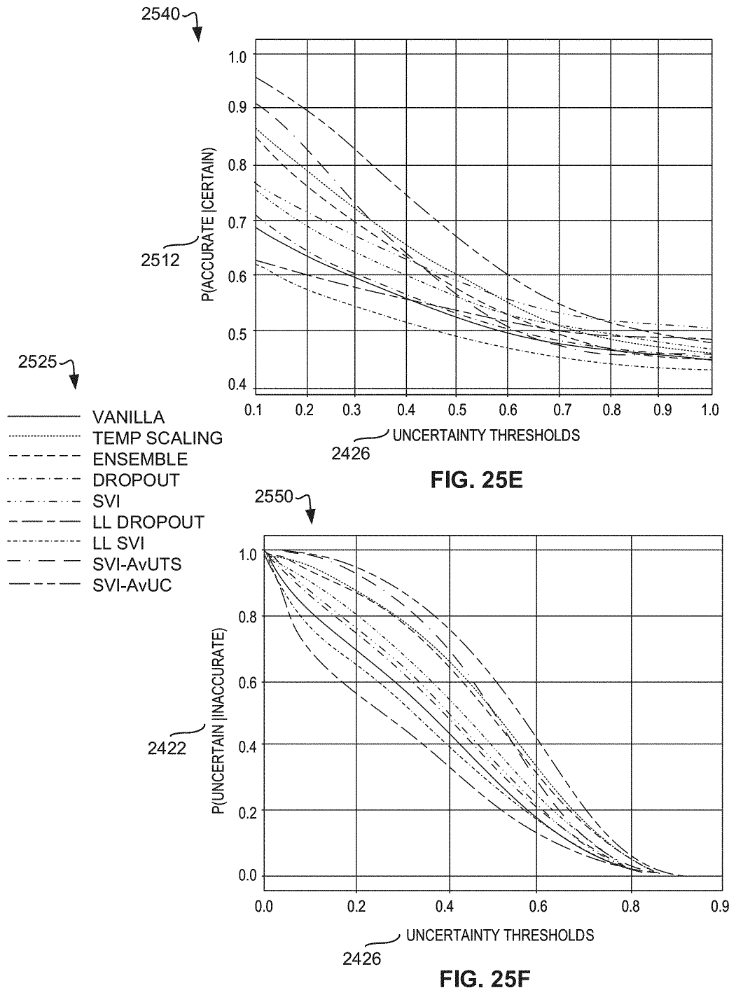

FIGS. 25A-25F illustrate example results 2520, 2530, 2540, 2550 for confidence and uncertainty evaluation under distributional shift using the speckle noise and shot noise image corruptions on CIFAR datasets. FIGS. 25A, 25D show example accuracy 2402 as a function of confidence, FIGS. 25B, 25E show example probability 2512 of the model being accurate on its predictions when it is certain, while FIGS. 25C, 25F show example probability 2422 of the model being uncertain when making inaccurate predictions. Normalized uncertainty thresholds t E [0,1] are shown, given that uncertainty range varies for different methods. In FIGS. 25A-25F, the SVI-AvUC model outperforms other example models 2505, 2525 when compared to these models.

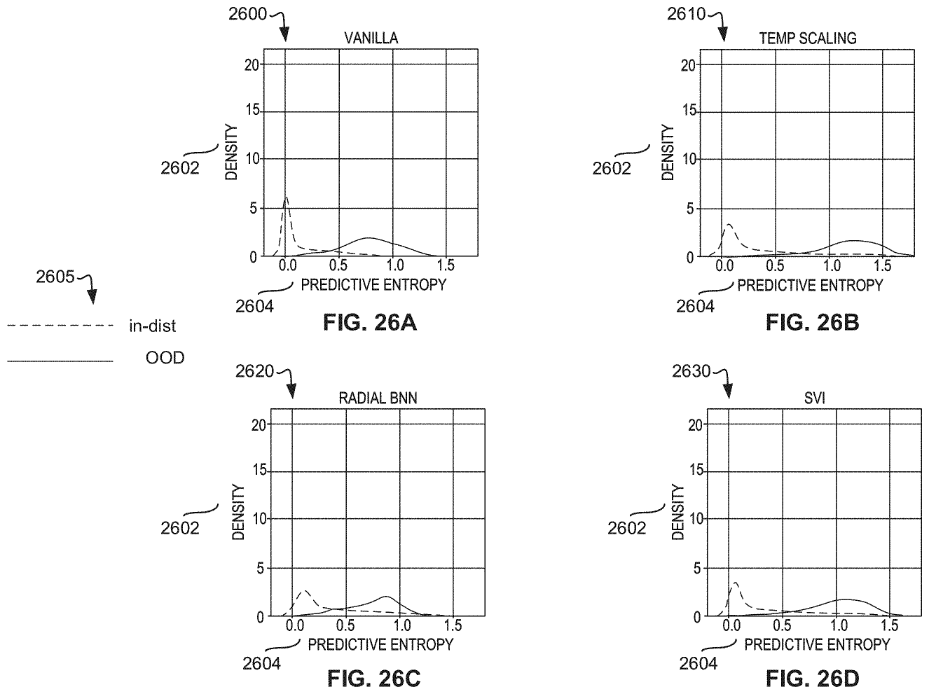

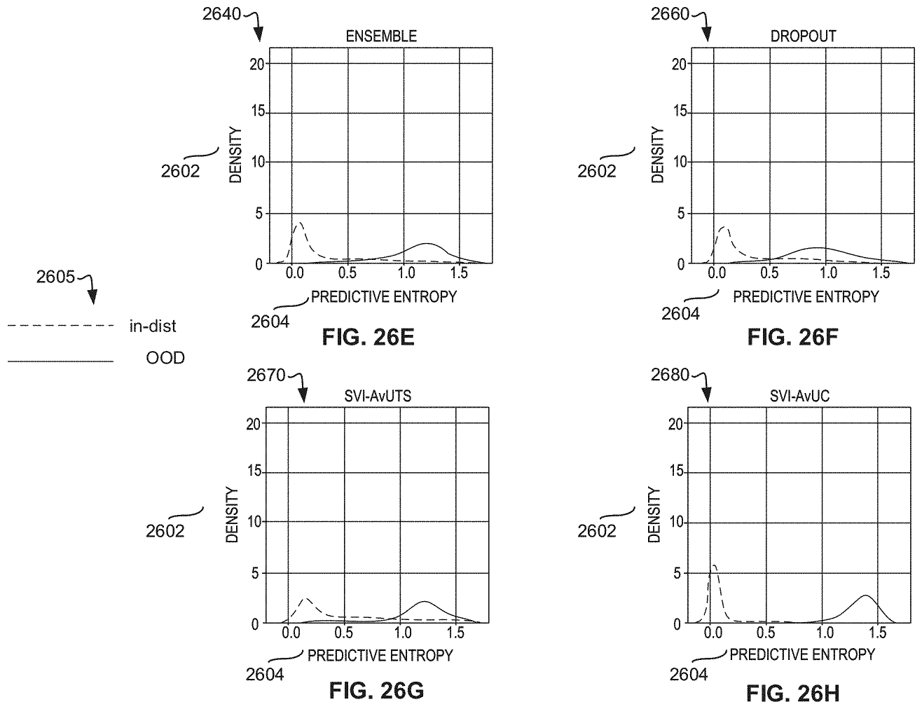

FIGS. 26A-26H illustrate density histograms 2600, 2610, 2620, 2630, 2640, 2660, 2670, 2680 of predictive entropy with example data 2605 (e.g., out-of-distribution (OOD) data and in-distribution data) based on ResNet-20 trained with CIFAR10. In the examples of FIGS. 26A-26H, which illustrate the density histograms for the various models being compared with SVI-AvUTS 2670 and/or SVI-AvUC 2680 (e.g., vanilla 2600, temperature scaling 2610, radial BNN 2620, SVI 2630, ensemble 2640, dropout 2660, etc.), the SVI-AvUC data set shows an optimal separation of densities between in-distribution data and out-of-distribution (OOD) data.

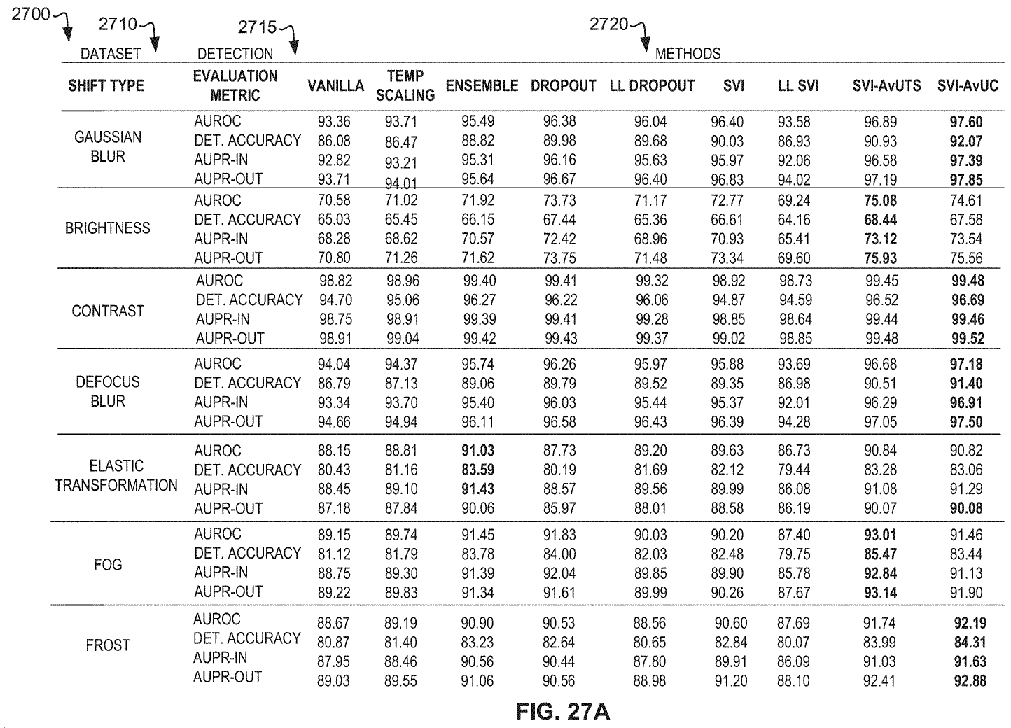

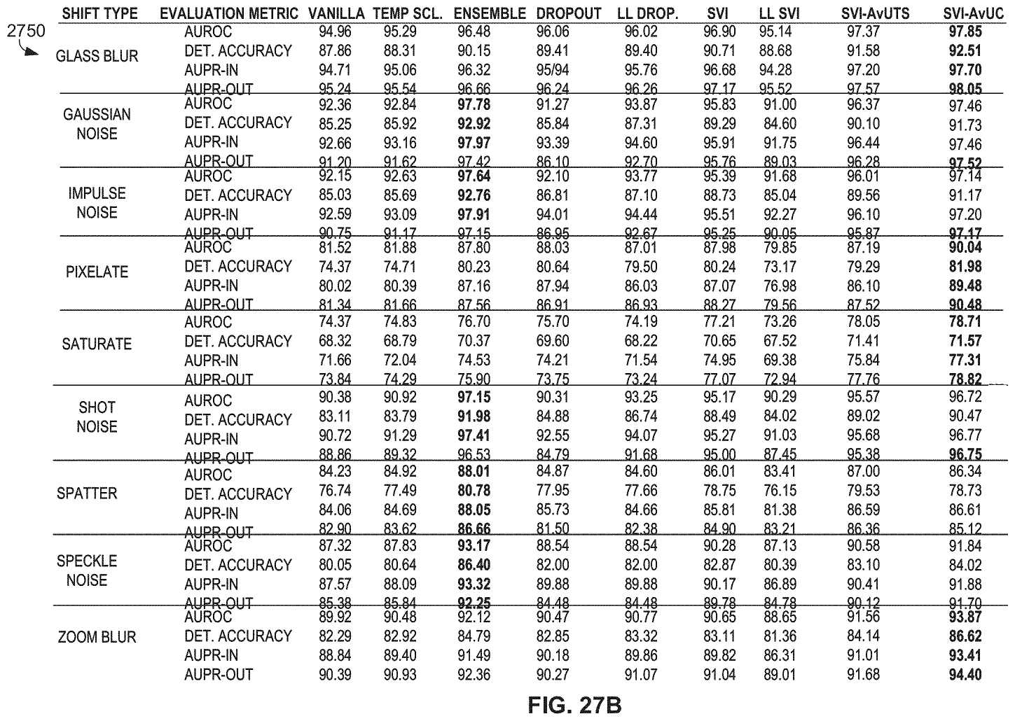

FIGS. 27A-27B illustrate example distributional shift detection 2700, 2750 using predictive entropy. In the example of FIGS. 27A-27B distributional shift detection performance is compared on 16 different types of dataset shift (e.g., each type including 50,000 shifted test images). Example dataset shift type 2710 includes various shifts as described in connection with FIG. 21 (e.g., gaussian blur, brightness, glass blur, gaussian noise, impulse noise, etc.), including various example evaluation metrics 2715 used to compare example methods 2720 described herein to the SVI-AvUTS and/or AVI-AvUC models. All values are percentages, with best results bolded to show the highest performing model for a given dataset shift type 2710 and/or evaluation metric 2715.

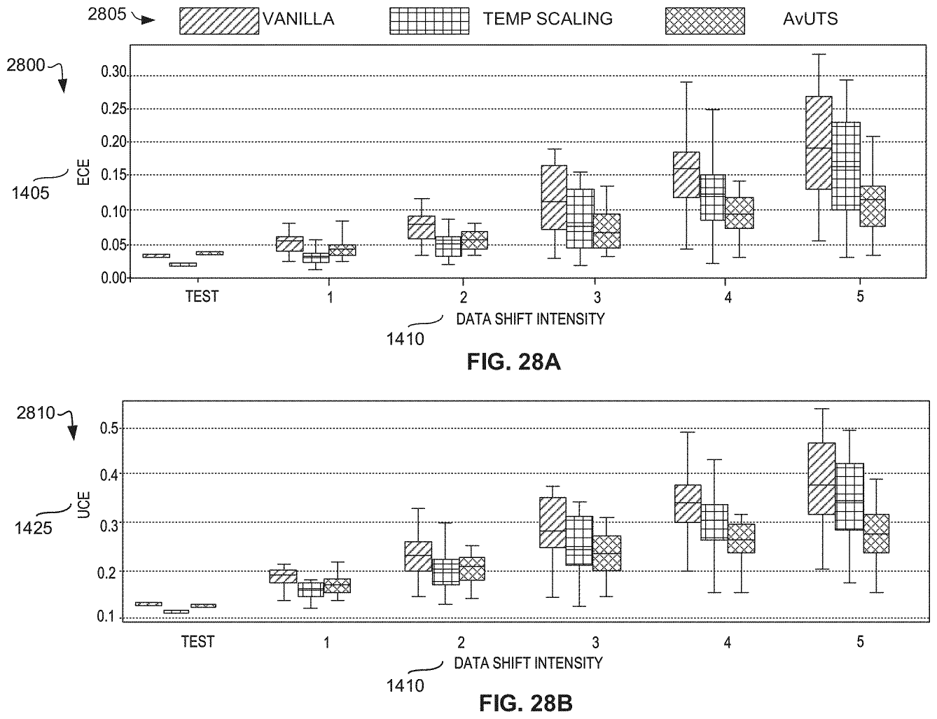

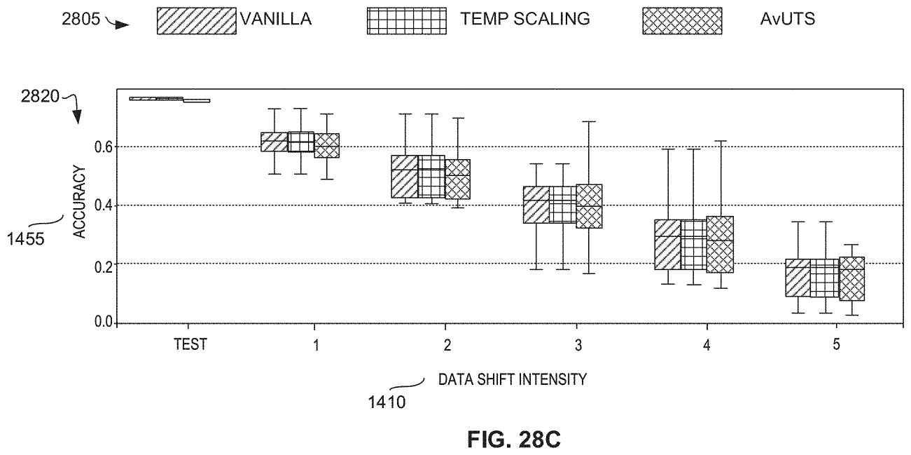

FIGS. 28A-28C illustrate results 2805, 2810, 2820 of AvU temperature scaling based on post-hoc calibration, including a comparison with conventional temperature scaling that optimizes negative log-likelihood loss. In the example of FIGS. 28A-28C, AvU temperature scaling (AvUTS) is evaluated by performing post-hoc calibration on vanilla DNN with accuracy versus uncertainty calibration (AvUC) loss, compared with conventional temperature scaling that optimizes negative log-likelihood loss. In some examples, entropy of softmax can be used as uncertainty for AvUC loss computation. In the example of FIGS. 28A-28C, model 2805 calibration comparisons are provided using example ECE 1405, UCE 1425, and accuracy 1455 comparisons on ImageNet under in-distribution and dataset shift at different levels of example shift intensities 1410. A well-calibrated model should provide lower calibration errors event at increased levels of data-shift. At each shift intensity level, boxplots illustrating results 2805, 2810, 2820 summarize the minimum, maximum, and quartile values. In the example of FIGS. 28A-28C, AvUTS provides significantly lower model calibration errors (ECE and UCE) than the vanilla and temperature scaling methods with increased distributional shift intensity, while providing comparable accuracy.

FIG. 29 is a block diagram of an example processor platform 2900 structured to execute the example machine readable instructions of FIGS. 7, 8, 9, 10, and/or 11 to implement the example uncertainty calibrator 520 of FIGS. 5 and/or 6. The processor platform 2900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box a digital camera, a headset or other wearable device, or any other type of computing device.

The processor platform 29 of the illustrated example includes a processor 2912. The processor 2912 of the illustrated example is hardware. For example, the processor 2912 can be implemented by one or more integrated circuits, logic circuits, microprocessors, GPUs, DSPs, or controllers from any desired family or manufacturer. The hardware processor 2912 may be a semiconductor based (e.g., silicon based) device. In this example, the processor implements the example threshold identifier 610, the example predicted class identifier 615, the example confidence identifier 620, the example uncertainty identifier 625, the example iterator 630, the example output calculator 635, the example stochastic model trainer 655, the example deterministic model trainer 660, the example neural network processor 665, and/or the example post-hoc calibrator 685.

The processor 2912 of the illustrated example includes a local memory 2913 (e.g., a cache). The processor 2912 of the illustrated example is in communication with a main memory including a volatile memory 2914 and a non-volatile memory 2916 via a link 2918. The link 2918 may be implemented by a bus, one or more point-to-point connections, etc., or a combination thereof. The volatile memory 2914 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 2916 may be implemented by flash memory and/or any other desired type of memory device. Access to the main memory 2914, 2916 is controlled by a memory controller.

The processor platform 2900 of the illustrated example also includes an interface circuit 2920. The interface circuit 2920 may be implemented by any type of interface standard, such as an Ethernet interface, a universal serial bus (USB), a Bluetooth® interface, a near field communication (NFC) interface, and/or a PCI express interface.

In the illustrated example, one or more input devices 2922 are connected to the interface circuit 2920. The input device(s) 2922 permit(s) a user to enter data and/or commands into the processor 2912. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface.

One or more output devices 2924 are also connected to the interface circuit 2920 of the illustrated example. The output devices 2924 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speakers(s). The interface circuit 2920 of the illustrated example, thus, typically includes a graphics driver card, a graphics driver chip and/or a graphics driver processor.

The interface circuit 2920 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 2926. The communication can be via, for example, an Ethernet connection, a digital subscriber line (DSL) connection, a telephone line connection, a coaxial cable system, a satellite system, a line-of-site wireless system, a cellular telephone system, etc.

The processor platform 2900 of the illustrated example also includes one or more mass storage devices 2928 for storing software and/or data. Examples of such mass storage devices 2928 include floppy disk drives, hard drive disks, compact disk drives, Blu-ray disk drives, redundant array of independent disks (RAID) systems, and digital versatile disk (DVD) drives.

The machine executable instructions 2932 corresponding to the instructions of FIGS. 7, 8, 9, 10, and/or 11 may be stored in the mass storage device 2928, in the volatile memory 2914, in the non-volatile memory 2916, in the local memory 2913 and/or on a removable non-transitory computer readable storage medium, such as a CD or DVD 2936.

A block diagram 3000 illustrating an example software distribution platform 3005 to distribute software such as the example computer readable instructions 2932 of FIG. 29 to third parties is illustrated in FIG. 30. The example software distribution platform 3005 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 2932 of FIG. 29. The third parties may be consumers, users, retailers, OEMs, etc., who purchase and/or license the software for use and/or re-sale and/or sub-licensing. In the illustrated example, the software distribution platform 3005 includes one or more servers and one or more storage devices. The storage devices store the computer readable instructions 2932, which may correspond to the example computer readable instructions of FIG. 29, as described above. The one or more servers of the example software distribution platform 3005 are in communication with a network 3010, which may correspond to any one or more of the Internet and/or any of the example networks 2926 described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 2932 from the software distribution platform 3005. For example, the software, which may correspond to the example computer readable instructions of FIGS. 7, 8, 9, 10, and/or 11, may be downloaded to the example processor platform 3000, which is to execute the computer readable instructions 2932. In some examples, one or more servers of the software distribution platform 3005 periodically offer, transmit, and/or force updates to the software (e.g., the example computer readable instructions 2932 of FIG. 29) to ensure improvements, patches, updates, etc. are distributed and applied to the software at the end user devices.

From the foregoing, it will be appreciated that methods disclosed herein investigate the effect of accounting predictive uncertainty estimation in the training objective function towards model calibration under dataset shift, and utilize an approach that leverages the relationship between accuracy and uncertainty as an anchor for uncertainty calibration while training deep neural network classifiers (Bayesian and non-Bayesian). A differentiable proxy for Accuracy versus Uncertainty (AvU) measure and corresponding AvU loss function devised to obtain well-calibrated uncertainties is introduced, while maintaining or improving model accuracy. Additionally, a post-hoc model calibration extending the temperature scaling using AvU loss is described. Empirical evaluation of the proposed methods and their comparison with existing high-performing baselines on large-scale image classification tasks using a wide range of metrics demonstrates that the example approaches disclosed herein yield state-of-the-art model calibration even under distributional shift (data shift and out-of-distribution). Additionally, the distributional shift detection performance using predictive uncertainty estimates obtained from different methods is compared. As AI systems backed by deep learning are being introduced in safety-critical applications (e.g., autonomous vehicles, medical diagnosis, robotics, etc.), it is important for these systems to be explainable and trustworthy for successful deployment in real-world scenarios. Having the ability to derive uncertainty estimates provides an important advancement for AI systems based on deep learning. Furthermore, calibrated uncertainty quantification provides grounding for uncertainty measurements in such models, such that AI practitioners can better understand predictions for reliable decision-making (e.g., knowing “when to trust” and “when not to trust” the model predictions). Well-calibrated uncertainty measures can be used as input for building fair and trustworthy AI models that implement explainable behavior, which is critical for building AI systems that are robust to adversarial attacks and permit the overall advancement of self-learning systems.

Example methods, apparatus, systems, and articles of manufacture to obtain well-calibrated uncertainty in deep neural networks are disclosed herein. Further examples and combinations thereof include the following:

Example 1 includes an apparatus comprising a loss function determiner to determine a differentiable accuracy versus uncertainty loss function for a machine learning model, a training controller to train the machine learning model, the training including performing an uncertainty calibration of the machine learning model using the loss function, and a post-hoc calibrator to optimize the loss function using temperature scaling to improve the uncertainty calibration of the trained machine learning model under distributional shift.

Example 2 includes the apparatus of example 1, wherein the training controller is to train the model using the determined loss function in combination with negative evidence lower bound (ELBO) loss.

Example 3 includes the apparatus of example 2, further including a threshold identifier to determine an uncertainty threshold during an initial model training epoch, the model trained with the ELBO loss.

Example 4 includes the apparatus of example 3, wherein the threshold identifier is to determine the uncertainty threshold based on a predictive uncertainty mean for accurate predictions or inaccurate predictions.

Example 5 includes the apparatus of example 1, wherein the training controller includes a stochastic model trainer or a deterministic model trainer.

Example 6 includes the apparatus of example 5, wherein the stochastic model trainer is to train a stochastic neural network using the determined loss function, the loss function based on a predictive distribution determined from stochastic forward passes during training.

Example 7 includes the apparatus of example 5, wherein the deterministic model trainer is to train a deterministic neural network using the determined loss function, the loss function based on a predictive uncertainty determined using entropy of softmax.

Example 8 includes the apparatus of example 1, wherein the post-hoc calibrator is to identify an optimal temperature while minimizing the loss function on hold-out validation data.

Example 9 includes the apparatus of example 1, wherein training output includes at least one of (1) a number of inaccurate and uncertain predictions, (2) a number of accurate and certain predictions, a number of inaccurate and certain predictions, or (3) a number of accurate and uncertain predictions.

Example 10 includes a method, comprising determining a differentiable accuracy versus uncertainty loss function for a machine learning model, training the machine learning model, the training including performing an uncertainty calibration of the machine learning model using the loss function, and optimizing the loss function using temperature scaling to improve the uncertainty calibration of the trained machine learning model under distributional shift.

Example 11 includes the method of example 10, wherein the training includes training the model using the determined loss function in combination with negative evidence lower bound (ELBO) loss.

Example 12 includes the method of example 11, further including determining an uncertainty threshold during an initial model training epoch, the model trained with the ELBO loss.

Example 13 includes the method of example 12, wherein the uncertainty threshold is determined based on a predictive uncertainty mean for accurate predictions or inaccurate predictions.

Example 14 includes the method of example 10, wherein the machine learning model is a stochastic model or a deterministic model.

Example 15 includes the method of example 14, wherein stochastic model training includes training a stochastic neural network using the determined loss function, the loss function based on a predictive distribution determined from stochastic forward passes during training.

Example 16 includes the method of example 14, wherein deterministic model training includes training a deterministic neural network using the determined loss function, the loss function based on a predictive uncertainty determined using entropy of softmax.

Example 17 includes the method of example 10, wherein training output includes at least one of (1) a number of inaccurate and uncertain predictions, (2) a number of accurate and certain predictions, a number of inaccurate and certain predictions, or (3) a number of accurate and uncertain predictions.

Example 18 includes at least one non-transitory computer readable medium comprising instructions that, when executed, cause at least one processor to at least determine a differentiable accuracy versus uncertainty loss function for a machine learning model, train the machine learning model, the training including performing an uncertainty calibration of the machine learning model using the loss function, and optimize the loss function using temperature scaling to improve the uncertainty calibration of the trained machine learning model under distributional shift.

Example 19 includes the at least one non-transitory computer readable medium as defined in example 18, wherein the instructions, when executed, cause the at least one processor to train the model using the determined loss function in combination with negative evidence lower bound (ELBO) loss.

Example 20 includes the at least one non-transitory computer readable medium as defined in example 18, wherein the instructions, when executed, cause the at least one processor to train a stochastic neural network using the determined loss function, the loss function based on a predictive distribution determined from stochastic forward passes during training.

Example 21 includes the at least one non-transitory computer readable medium as defined in example 18, wherein the instructions, when executed, cause the at least one processor to output at least one of (1) a number of inaccurate and uncertain predictions, (2) a number of accurate and certain predictions, a number of inaccurate and certain predictions, or (3) a number of accurate and uncertain predictions.

Example 22 includes the at least one non-transitory computer readable medium as defined in example 18, wherein the instructions, when executed, cause the at least one processor to determine optimal temperature associated with post-hoc model calibration while minimizing the accuracy versus uncertainty loss function.

Example 23 includes an apparatus, comprising means for determining a differentiable accuracy versus uncertainty loss function for a machine learning model, means for training machine learning model, the training including performing an uncertainty calibration of the machine learning model using the loss function, and means for optimizing the loss function using temperature scaling to improve the uncertainty calibration of the trained machine learning model under distributional shift.

Example 24 includes the apparatus of example 23, wherein the means for training include training the model using the determined loss function in combination with negative evidence lower bound (ELBO) loss.

Example 25 includes the apparatus of example 24, further including means for determining an uncertainty threshold during an initial model training epoch, the model trained with the ELBO loss.

Example 26 includes the apparatus of example 25, wherein the means for determining an uncertainty threshold include determining the uncertainty threshold based on a predictive uncertainty mean for accurate predictions or inaccurate predictions.

Example 27 includes the apparatus of example 23, wherein the means for training include means for training a stochastic model or means for training a deterministic model.

Example 28 includes the apparatus of example 27, wherein the means for training a stochastic model include training a stochastic neural network using the determined loss function, the loss function based on a predictive distribution determined from stochastic forward passes during training.

Example 29 includes the apparatus of example 27, wherein the means for training a deterministic model include training a deterministic neural network using the determined loss function, the loss function based on a predictive uncertainty determined using entropy of softmax.

Example 30 includes the apparatus of example 23, wherein the means for optimizing the loss function include identifying an optimal temperature while minimizing the loss function on hold-out validation data.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An apparatus comprising:
a loss function determiner to determine a differentiable accuracy versus uncertainty loss function for a machine learning model;
a training controller to train the machine learning model, the training including performing an uncertainty calibration of the machine learning model using the loss function; and
a post-hoc calibrator to optimize the loss function using temperature scaling to improve the uncertainty calibration of the trained machine learning model under distributional shift.

2. The apparatus of claim 1, wherein the training controller is to train the model using the determined loss function in combination with negative evidence lower bound (ELBO) loss.

3. The apparatus of claim 2, further including a threshold identifier to determine an uncertainty threshold during an initial model training epoch, the model trained with the ELBO loss.

4. The apparatus of claim 3, wherein the threshold identifier is to determine the uncertainty threshold based on a predictive uncertainty mean for accurate predictions or inaccurate predictions.

5. The apparatus of claim 1, wherein the training controller includes a stochastic model trainer or a deterministic model trainer.

6. The apparatus of claim 5, wherein the stochastic model trainer is to train a stochastic neural network using the determined loss function, the loss function based on a predictive distribution determined from stochastic forward passes during training.

7. The apparatus of claim 5, wherein the deterministic model trainer is to train a deterministic neural network using the determined loss function, the loss function based on a predictive uncertainty determined using entropy of softmax.

8. The apparatus of claim 1, wherein the post-hoc calibrator is to identify an optimal temperature, the optimal temperature identified by minimizing the loss function on hold-out validation data, the hold-out validation data used to determine the temperature value.

9. The apparatus of claim 1, wherein training output includes at least one of (1) a number of inaccurate and uncertain predictions, (2) a number of accurate and certain predictions, a number of inaccurate and certain predictions, or (3) a number of accurate and uncertain predictions.

10. A method, comprising:
determining a differentiable accuracy versus uncertainty loss function for a machine learning model;
training the machine learning model, the training including performing an uncertainty calibration of the machine learning model using the loss function; and
optimizing the loss function using temperature scaling to improve the uncertainty calibration of the trained machine learning model under distributional shift.

11. The method of claim 10, wherein the training includes training the model using the determined loss function in combination with negative evidence lower bound (ELBO) loss.

12. The method of claim 11, further including determining an uncertainty threshold during an initial model training epoch, the model trained with the ELBO loss.

13. The method of claim 12, wherein the uncertainty threshold is determined based on a predictive uncertainty mean for accurate predictions or inaccurate predictions.

14. The method of claim 10, wherein the machine learning model is a stochastic model or a deterministic model.

15. The method of claim 14, wherein stochastic model training includes training a stochastic neural network using the determined loss function, the loss function based on a predictive distribution determined from stochastic forward passes during training.

16. The method of claim 14, wherein deterministic model training includes training a deterministic neural network using the determined loss function, the loss function based on a predictive uncertainty determined using entropy of softmax.

17. The method of claim 10, wherein training output includes at least one of (1) a number of inaccurate and uncertain predictions, (2) a number of accurate and certain predictions, a number of inaccurate and certain predictions, or (3) a number of accurate and uncertain predictions.

18. At least one non-transitory computer readable medium comprising instructions that, when executed, cause at least one processor to at least:
determine a differentiable accuracy versus uncertainty loss function for a machine learning model;
train the machine learning model, the training including performing an uncertainty calibration of the machine learning model using the loss function; and
optimize the loss function using temperature scaling to improve the uncertainty calibration of the trained machine learning model under distributional shift.

19. The at least one non-transitory computer readable medium as defined in claim 18, wherein the instructions, when executed, cause the at least one processor to train the model using the determined loss function in combination with negative evidence lower bound (ELBO) loss.

20. The at least one non-transitory computer readable medium as defined in claim 18, wherein the instructions, when executed, cause the at least one processor to train a stochastic neural network using the determined loss function, the loss function based on a predictive distribution determined from stochastic forward passes during training.

21. The at least one non-transitory computer readable medium as defined in claim 18, wherein the instructions, when executed, cause the at least one processor to output at least one of (1) a number of inaccurate and uncertain predictions, (2) a number of accurate and certain predictions, a number of inaccurate and certain predictions, or (3) a number of accurate and uncertain predictions.

22. The at least one non-transitory computer readable medium as defined in claim 18, wherein the instructions, when executed, cause the at least one processor to determine optimal temperature associated with post-hoc model calibration while minimizing the accuracy versus uncertainty loss function.

23.-30. (canceled)
